(19) United States
(12) Patent Application Publication
(10) Pub. No.: US 2024/0003845 A1
(43) Pub. Date: Jan. 4, 2024

(54) DIFFERENTIAL CURRENT LIMITING FOR VOLTAMMETRY SENSOR LIFETIME EXTENSION

(71) Applicants: Brewer Science, Inc., Rolla, MO (US); Department of the Army, Vicksburg, MS (US)

(72) Inventors: Jonathan J. Fury, Springfield, MO (US); Anton Netchaev, Clinton, MS (US); Jason Ray, Madison, MS (US); Keith Conley, Clinton, MS (US); Eric Brown, Vicksburg, MS (US)

(21) Appl. No.: 17/855,866

(22) Filed: Jul. 1, 2022

(51) Int. Cl. G01N 27/416; G01N 27/48

(52) U.S. Cl. CPC G01N 27/4163; G01N 27/48

(57) ABSTRACT

In one embodiment, a voltammetry sensor measurement system includes one or more potentiostats configured to transmit an electrical input to a working electrode of a voltammetry sensor and to measure an electrical output from the voltammetry sensor in response to the electrical input, the electrical input including a square wave electrical input, the measured electrical output including a differential current through the working electrode. A controller is coupled with the potentiostats to monitor, in real time, the differential current through the working electrode. The controller is configured to determine if the monitored differential current will exceed a preset differential current threshold of the voltammetry sensor, using a predictive algorithm based on the monitored differential current, before the differential current reaches the threshold; and to generate a signal when the monitored differential current is determined to exceed the threshold, to preserve the voltammetry sensor before the differential current reaches the threshold.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### STATEMENT REGARDING FEDERALLY SPONSORED RESEARCH OR DEVELOPMENT

This invention was also made with Government support under W912HZ-18-2-0003 entitled “PRINTED ELECTRONIC NANO CARBON-BASED DEVICES AND SYSTEMS TO IMPROVE REAL-TIME SURFACE WATER CONTAMINATION SENSING,” subaward 18004-001, awarded by the Department of the Army ERDC. The United States Government has certain rights in the invention.

### BACKGROUND

### Field of the Invention

The present invention relates to sensors and, more specifically, to systems and methods of protecting voltammetry sensors from damage to the voltammetry sensor electrodes due to high differential currents.

### Description of the Related Art

This section introduces aspects that may help facilitate a better understanding of the invention. Accordingly, the statements of this section are to be read in this light and are not to be understood as admissions about what is prior art or what is not prior art.

Physical damage of sensors such as voltammetry sensors is a problem. An example of damage involves delamination of electrodes. Damaged sensors produce inconsistent and unreliable measurements. Heretofore in general, damaged sensors are discarded because they are inexpensive and can be easily replaced.

### SUMMARY

The present invention was developed to address the desire for extending the lifetime of sensors such as voltammetry sensors. Research and development have led to a novel approach of protecting such sensors from excessive currents to extend their lifetime.

Application of high electrical currents for extended periods can cause sensor damage by electrodeposition of metallic ions onto the sensor electrodes. This process changes the electrical conductivity of the sensor, and damaged sensors produce inconsistent and unreliable measurements. An excessive differential current can damage the sensor electrodes and deem it unusable which is highly problematic especially for sensors deployed to remote locations.

Embodiments of the present invention provide a predictive algorithm for monitoring a differential current of square wave voltammetry of a voltammetry sensor such as an electrochemical sensor, predicting what future values of the current response will be base on previous trends, and comparing the future values to a preset differential current threshold, so that before the threshold is reached, the algorithm may stop the voltammetry process to preserve the sensor and/or produce an alert to notify the operator who may take remedial action

The present invention advances the science of electrochemical measurements, especially as it relates to performing such measurements in forward operating environments to monitor the area for chemical contaminants of interests (analytes). Key to the success of this apparatus is, among others, the ability to protect remotely deployed sensors from becoming damaged and unusable due to excessive differential current. Embodiments of the invention address the problem of physical damage of a three-electrode sensor due to the application of high differential currents for extended periods in square wave voltammetry, which causes electrodeposition of metallic ions onto the sensor electrodes. At the heart of the endeavor is a custom printed circuit board (PCB) that is based around an integrated component (IC) which is a microcontroller and potentiostat combination that allows for traditional electrochemical techniques to be performed in a low cost, low power, minimum component package or system on chip (SoC).

In one example, an electrochemical voltammetry system employs at least three electrochemical methodologies: cyclic voltammetry, square wave voltammetry, and electrochemical impedance spectroscopy. These three measurements are each made by a potentiostat coupled to a three-electrode sensor which has a working electrode, a reference electrode, and a counter electrode. The system quantifies the presence of analytes by applying a known signal to the working electrode and measuring the response on the three-electrode sensor. For square wave voltammetry, the applied square wave signal has a differential current that can vary during the voltammetry process of quantifying the presence of analytes. Application of high differential currents for extended periods can cause physical damage of the three-electrode sensor by electrodeposition of metallic ions onto the sensor electrodes. The dissolution of metal ions/oxidation can destroy an electrode. Any such destruction to the electrode is detrimental because the surface area will change.

To protect the electrode surface from high differential currents of the square wave voltammetry, an embodiment of the invention involves monitoring, in real time, the differential current through the working electrode and using a predictive algorithm to determine if the differential current will exceed a differential current threshold. The predictive algorithm makes use of past, present, and predicted future values of the differential current in square wave voltammetry to anticipate whether or not a differential current threshold limit will be reached. Currently this limit is set by the operator but as more testing is done, a more accurate value may emerge which will be a more test proven value for a particular set of electrodes in the electrochemical sensor. The algorithm will work with other electrodes utilizing square wave voltammetry, but the thresholds may be different. If the sensor is on a trajectory to exceed the differential current threshold limit, the algorithm may stop the voltammetry process to preserve the sensor and/or produce an alert to notify the operator who may take remedial action.

According to an aspect the present invention, a voltammetry sensor measurement system comprises: one or more potentiostats configured to transmit an electrical input to a working electrode of an voltammetry sensor and to measure an electrical output from the voltammetry sensor in response to the transmitted electrical input, the electrical input including a square wave electrical input, the measured electrical output including a differential current through the working electrode of the voltammetry sensor; and a controller coupled with the one or more potentiostats to monitor, in real time, the differential current through the working electrode of the voltammetry sensor. The controller is configured to determine if the monitored differential current will exceed a preset differential current threshold of the voltammetry sensor, using a predictive algorithm based on the monitored differential current, before the differential current reaches the differential current threshold. The controller is configured to generate a signal when the monitored differential current is determined to exceed the preset differential current threshold, to preserve the voltammetry sensor before the differential current reaches the differential current threshold.

In some embodiments, the predictive algorithm makes use of past, present, and predicted future values of the differential current to anticipate whether or not the differential current will reach the preset differential current threshold before the differential current reaches the differential current threshold. The controller may be configured, when the monitored differential current is determined to exceed the preset differential current threshold, to perform at least one of generating an alert or stopping the square wave electrical input from the one or more potentiostats to the voltammetry sensor, before the differential current reaches the differential current threshold. A user interface may be coupled with the controller to send information to and receive information from the controller and the alert may be sent to the user interface. The user interface may be coupled with the controller via a wireless connection.

In specific embodiments, the square wave electrical input comprises a square wave voltage applied between the working electrode and a reference electrode of the voltammetry sensor and the differential current is obtained based on a current measured between the working electrode and a counter electrode of the voltammetry sensor.

In some embodiments, a sensor capsule includes a plurality of sensor packages, each sensor package comprising a voltammetry sensor measurement system and a voltammetry sensor connected with the voltammetry sensor measurement system. Each sensor package includes a communications subsystem having wireless communication capability to transmit and receive data wirelessly. The sensor capsule may be configured to be deployable to a remote location and release and distribute the plurality of sensor packages at the remote location and the plurality of sensor packages may include communications subsystems having wireless communication capability to communicate via a wide area network (WAN).

In accordance with another aspect of the invention, a differential current limiting method for a voltammetry system comprises: configuring one or more potentiostats to transmit an electrical input to a working electrode of an voltammetry sensor and to measure an electrical output from the voltammetry sensor in response to the transmitted electrical input, the electrical input including a square wave electrical input, the measured electrical output including a differential current through the working electrode of the voltammetry sensor; monitoring, in real time, the differential current through the working electrode of the voltammetry sensor; determining if the monitored differential current will exceed a preset differential current threshold of the voltammetry sensor, using a predictive algorithm based on the monitored differential current, before the differential current reaches the differential current threshold; and generating a signal when the monitored differential current is determined to exceed the preset differential current threshold, to preserve the voltammetry sensor before the differential current reaches the differential current threshold.

In specific embodiments, a sensor capsule is deployed to a remote location, the sensor capsule including a plurality of sensor packages, each sensor package comprising one voltammetry sensor measurement system connected with one voltammetry sensor. The plurality of sensor packages are distributed at the remote location. The plurality of sensor packages may be configured with wireless communication capability to transmit and receive data wirelessly and to communicate via a WAN.

In accordance with yet another aspect of this invention, an electrochemical sensor measurement system comprises: one or more potentiostats configured to transmit an electrical input to a working electrode of an electrochemical sensor and to measure an electrical output from the electrochemical sensor in response to the transmitted electrical input, the electrical input including a square wave electrical input, the measured electrical output including a differential current through the working electrode of the electrochemical sensor; and a controller coupled with the one or more potentiostats to monitor, in real time, the differential current through the working electrode of the electrochemical sensor. The controller is configured to determine if the monitored differential current will exceed a preset differential current threshold of the electrochemical sensor, using a predictive algorithm based on the monitored differential current, before the differential current reaches the differential current threshold. The controller is configured to generate a signal when the monitored differential current is determined to exceed the preset differential current threshold, to preserve the electrochemical sensor before the differential current reaches the differential current threshold.

In some embodiments, a sensor capsule includes a plurality of sensor packages, each sensor package comprising an electrochemical sensor measurement system and an electrochemical sensor connected with the electrochemical sensor measurement system. The sensor capsule is configured to be deployable to a remote location and release and distribute the plurality of sensor packages at the remote location. The plurality of sensor packages include communications subsystems having wireless communication capability to transmit and receive data wirelessly.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a block diagram of a voltammetry system according to an embodiment of the present invention.

FIG. 2A shows an example of a 3-electrode sensor coupled to a potentiostat.

FIG. 2B shows an example of a simplified potentiostat circuitry.

FIG. 3A shows an example of a cyclic voltammogram excitation signal.

FIG. 3B shows an example of a cyclic voltammetry algorithm.

FIG. 4 shows an example of a simplified square wave voltammetry forcing function or excitation signal with measurement points.

FIG. 5A shows details of the signal of FIG. 4 illustrating an example of the SWV measurement methodology.

FIG. 5B shows an example of a square wave voltammetry algorithm.

FIG. 6 shows an example of a sinusoidal current response in a linear system (a) and Lissajous curve indicative of a linear system (b) for electrochemical impedance spectroscopy.

FIG. 7A shows an example of a Nyquist plot of a simplified Randles Cell.

FIG. 7B shows a table of impedance formulas according to one embodiment.

FIG. 7C shows an example of Randles Cell as an equivalent circuit with mixed kinetic and charge-transfer control.

FIG. 8 shows an example of a cyclic voltammogram for CV.

FIG. 9 shows an example of a square wave voltammogram for SWV.

FIG. 10 shows an example of a Randles circuit impedance spectroscopy Nyquist plot for EIS.

FIG. 11 shows an example of an impedance Bode magnitude plot for EIS.

FIG. 12 shows an example of an impedance Bode phase plot for EIS.

FIG. 13 is a flow diagram illustrating an example of a process of differential current limiting for voltammetry sensor lifetime extension.

FIG. 14 shows an example of a simplified square wave voltammetry forcing function or excitation signal used in sensor test cases to illustrate the process of differential current limiting.

FIG. 15 shows an example of sampling points which are used to calculate differential current for each square wave cycle in the example of FIG. 14.

FIG. 16 shows an example of a full test output of a square wave voltammogram for a sensor test case of FIG. 14 in which the projected differential current does not exceed the differential current threshold.

FIGS. 17A-17F show partial test outputs of the square wave voltammogram in the example of FIG. 16.

FIGS. 18A-18C show partial test outputs of another example of a square wave voltammogram for another sensor test case of FIG. 14 in which the projected differential current exceeds the differential current threshold.

FIG. 19 shows an example of meshing routes.

FIG. 20 shows an example the architecture of the LoRaWAN network.

FIG. 21 shows an example of a sensor capsule.

FIG. 22 depicts an exemplary computer system or device configured for a voltammetry system controller according to an embodiment of the present invention.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Embodiments of the present invention address the problem of sensor damage due to excessive differential current by (i) monitoring a differential current through the working electrode of a voltammetry sensor and using a predictive algorithm to determine if the differential current will exceed a differential current threshold of the sensor before it actually reaches the threshold, and (ii) if the sensor is on a trajectory to exceed the differential current limits, then stopping the voltammetry and/or generating an alert to preserve the sensor.

### Voltammetry System

A voltammetry sensor may be used as an electrochemical sensor for detecting and quantifying the presence of compounds such as chemical contaminants of interest (analytes). As the number of compounds to detect continues to increase, the methods needed to quantify minute changes in the surrounded medium grows with them. The study may begin with the need to detect nitrates, arsenic, and copper in water using resistance changes on a carbon nanotube sensor. Through the shortcomings discovered by the development of a resistance-based measurement metric, a more robust solution for detecting contaminates in the environment other than just using resistance would be required. Multiple electrochemical methodologies have been investigated, and there are currently three that may be deemed appropriate or necessary: cyclic voltammetry, square wave voltammetry, and electrochemical impedance spectroscopy. These three measurements may be made with a potentiostat circuit along with a 3-electrode setup. Different aspects of the system design include development of the 3-electrode sensor, the potentiostatic measurement platform, data transfer, and sensor deployment.

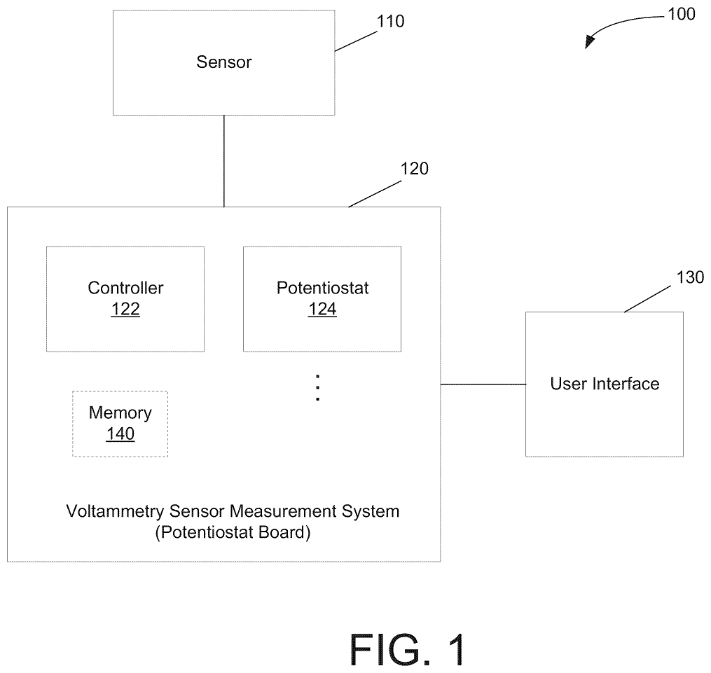

FIG. 1 is a block diagram of a voltammetry system according to an embodiment of the present invention. The voltammetry system 100 includes a sensor 110, which may be an electrochemical or a 3-electrode sensor, coupled to a potentiostat microcontroller combination 120 as an integrated component (IC) for performing electrochemical measurements based on sensor information received from the sensor 110. The combination 120 includes a controller 122 coupled with one or more potentiostats 124. The combination 120 is also referred to as a voltammetry or electrochemical sensor measurement system or a potentiostat board as discussed in more detail hereinbelow. A user interface 130 is coupled with the measurement system 120, which may be done via a wireless connection. The controller 122 in the measurement system 120 may have sufficient memory such as addressable memory to perform the processes of control and I/O (input/output) with the sensor 110 and user interface 130. If additional memory is needed or desired, a memory 140 may be added to the measurement system 120.

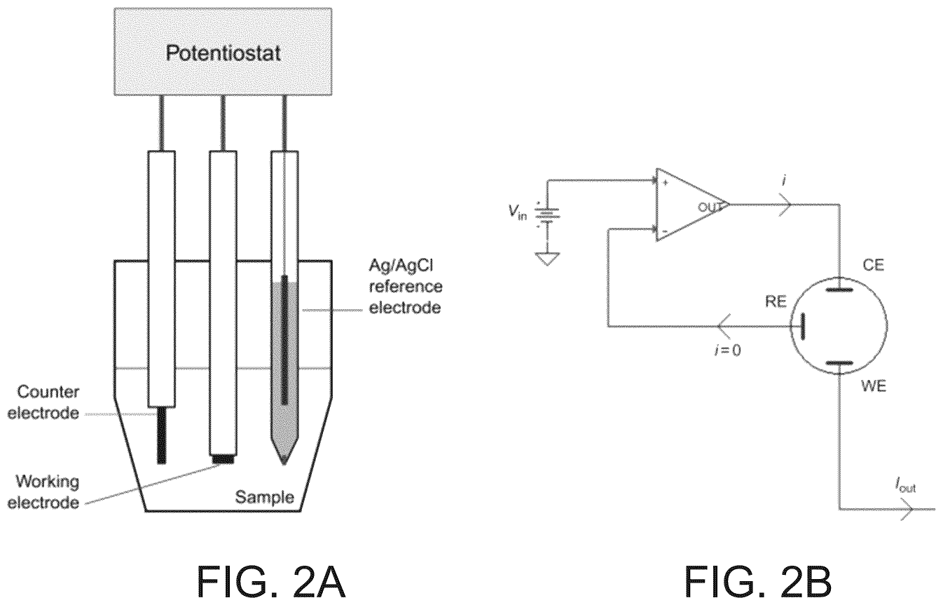

FIG. 2A shows an example of a 3-electrode sensor coupled to a potentiostat. The sensor includes a working electrode, a counter electrode, and a reference electrode for making measurements of the sample by applying a known signal to the working electrode and measuring the response with the potentiostat. In most cases, a potential is applied between the working and reference electrodes and the current is measured between the working and counter electrodes. Alternatively, a drive current may be applied between the working and counter electrodes and a potential is measured between the working and reference electrodes.

FIG. 2B shows an example of a simplified potentiostat circuitry. The potentiostat is an electrical network. In an example, it is designed to maintain potential changes between the working and reference electrodes of the 3-electrode sensor while measuring the current response between the working and counter electrodes. The complexity of the potentiostat circuit may be changed. Hardware may be identified and designed to be able to implement a more complex version of the simplified potentiostat along with being able to relay the information into a human interpretable format. The backend infrastructure may be built up to support the sensor platforms in the field and relay the information to personnel securely.

### Electrochemical Sensing

Cyclic Voltammetry

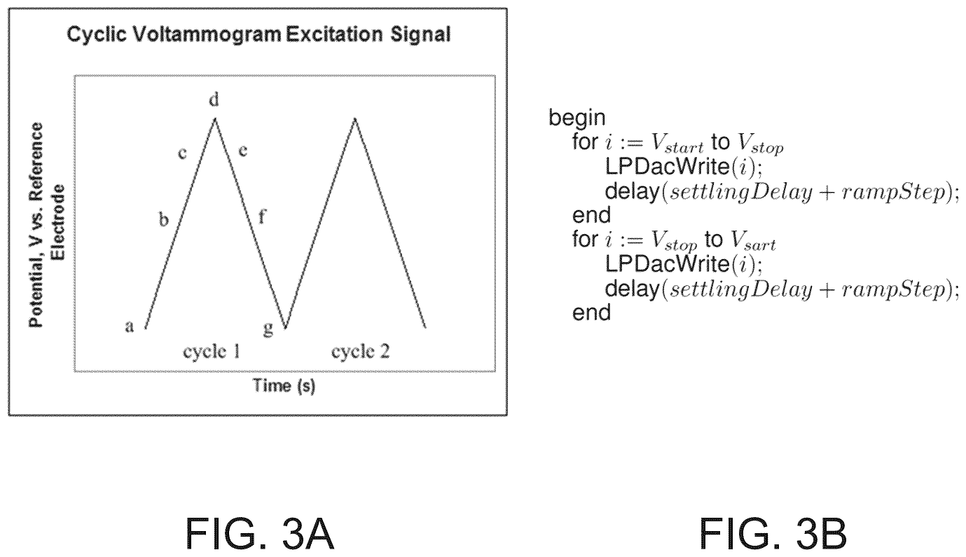

FIG. 3A shows an example of a cyclic voltammogram excitation signal. Cyclic voltammetry is an electrochemical measurement technique that measures the current produced when an electric potential is higher than the voltage potential predicted by a chemical's Nernst equation result. A potential is applied across the collector electrode. The potential is swept from one potential to another potential and then back again. The sweep potential can be seen in FIG. 3A. FIG. 3B shows an example of a cyclic voltammetry algorithm.

As cyclic voltammetry is a steadily increasing and decreasing signal, the implementation is two for loops followed by a delay equal to the Digital to Analog Converter settling time plus the delay for the ramp step.

A large concern with cyclic voltammetry is the faradaic currents generated during the reduction or oxidization induced by the voltammetry. The faradaic currents add noise into the overall measurement and as such they are considered by some to be unreliable. Faradaic currents are also induced by other voltammetry techniques, but with square wave voltammetry the potential difference is large enough that the noise does not affect the measurement as much.

Square Wave Voltammetry

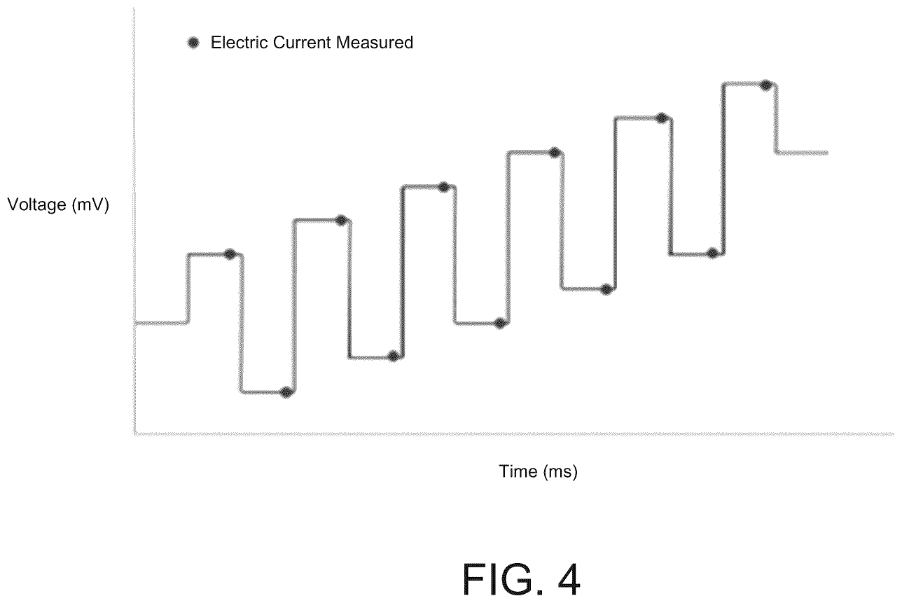

FIG. 4 shows an example of a simplified square wave voltammetry forcing function or excitation signal with measurement points. The introduction of square wave voltammetry (SWV) is based on an understanding of square wave polarography in trace analysis. The Faradaic current is measured at a time when the double layer charging current is negligible. The output waveform on the counter electrode consists of a square wave superimposed with a DC bias increase. The resulting combined waveform develops a staircase like output as seen in FIG. 4.

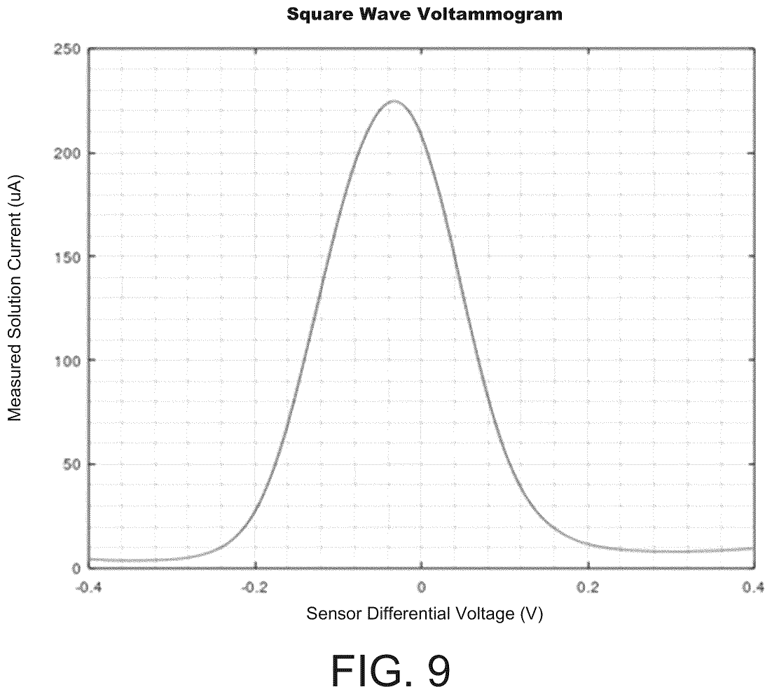

Square wave voltammetry is a form of linear potential sweep voltammetry that uses a combined square wave and staircase potential applied to a stationary electrode. It has found numerous applications in various fields, including within medicinal and various sensing communities. In a square wave voltammetric experiment, the current at a (usually stationary) working electrode is measured while the potential between the working electrode and a reference electrode is swept linearly in time. The potential waveform can be viewed as a superposition of a regular squarewave onto an underlying staircase (see FIG. 4); in this sense, SWV can be considered a modification of staircase voltammetry. The current is sampled at two times: once at the end of the forward potential pulse and again at the end of the reverse potential pulse (in both cases immediately before the potential direction is reversed). As a result of this current sampling technique, the contribution to the current signal resulting from capacitive (sometimes referred to as non-faradaic or charging) current is minimal. As a result of having current sampling at two different instances per squarewave cycle, two current waveforms are collected. Both have diagnostic value and are therefore preserved. When viewed in isolation, the forward and reverse current waveforms mimic the appearance of a cyclic voltammogram (which corresponds to the anodic or cathodic halves but is dependent upon experimental conditions). Despite the fact that both the forward and reverse current waveforms have diagnostic worth, it is almost always the case in SWV for the potentiostat software to plot a differential current waveform derived by subtracting the reverse current waveform from the forward current waveform. This differential curve is then plotted against the applied potential (see, e.g., FIG. 9).

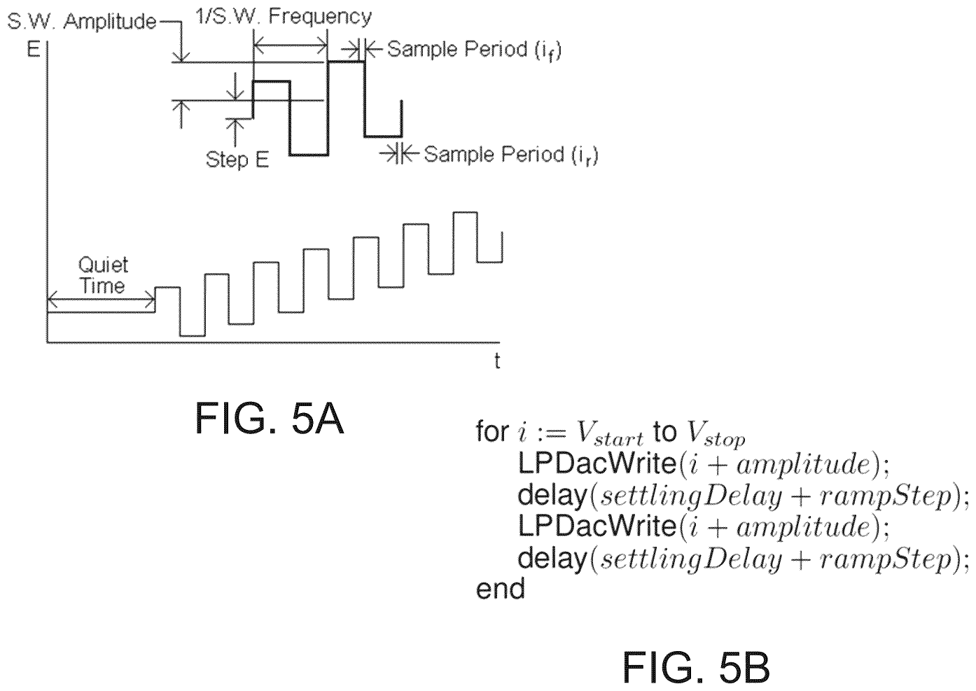

FIG. 5A shows details of the signal of FIG. 4 illustrating an example of the SWV measurement methodology.
Quiet Time=Calculated resistance of the sensor in Ohms
Step E=A prior known resistance of the reference resistor in Ohms
S.W. Amplitude=Measured voltage across the sensor in Volts
1/S.W. Frequency (i)=Measured voltage of the common bus in Volts
Scan Rate=How quickly a scan completes (determined by Step E)
Pulse Width=The length of the forward portion of each cycle (for SWV, it will be the same as the reverse portion)
Sampled Period (i_{f})=The first current measurement per step
Sampled Period (iᵣ)=The second current measurement per step
Ending Potential=Voltage potential that is the final potential of the run.

The current response for SWV is the difference between measured values in sample period i_{f} and iᵣ. Sampling lasts a few microseconds during each period. The current is measured as a representative voltage through the use of a trans-impedance amplifier. If the results are noisy, an average result can be obtained by taking several samples during the last third of each pulse. The quiet time is used to hold the electrode at a steady potential in order for the working electrode to accumulate reactant for the stripping process to function.

The scan rate of the measurements is determined by the step potential and the frequency as

$$\\ \frac{Step E}{τ}$$

and defines now quickly the reaction takes place. The difference in current response is plotted as a function of the step potential to produce the voltammogram.

The double layer charging current is determined by

$$\\ {e}^{( - \frac{t}{( RC )} )}$$

where t is time, R is the solution resistance and, and C is the double layer capacitance. The other contributing current measurement, the Faradaic current, is determined as

$$\\ {t}^{- \frac{1}{2}} .$$

Based on these two responses, the double layer capacitance current decays faster than the Faradaic current. This leads to the ability to measure the Faradaic current with the double layer capacitance current having a negligible effect.

FIG. 5B shows an example of a square wave voltammetry algorithm. The signal used in SWV is an increasing step function added to a square wave function. The increasing step function can be replicated with a loop and the square wave signal is mixed in by adding or subtracting the amplitude of the square wave.

Electrochemical Impedance Spectroscopy

Electrochemical Impedance Spectroscopy (EIS) is a measurement performed in frequency domain by the application of a sinusoidal signal (voltage) while measuring current. The excitation signal can be expressed as a function of time with Eₜ expressing potential at time t and E₀ is the amplitude of the signal with ω as the radial frequency:

Eₜ=E₀ sin(ωt)

The response signal in a linear system then can be expressed as:

Iₜ=I₀ sin(ωt+φ)

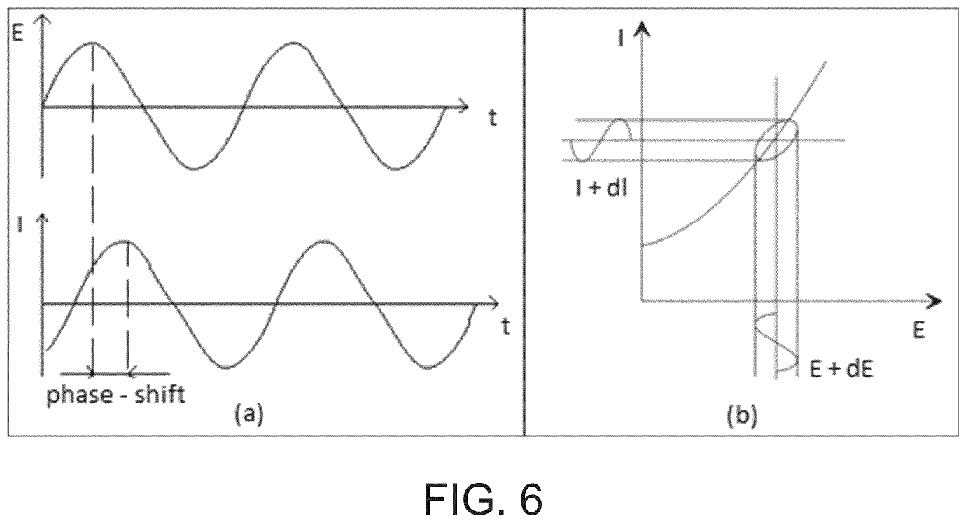

FIG. 6 shows an example of (a) a sinusoidal current response in a linear system and (b) Lissajous curve indicative of a linear system for electrochemical impedance spectroscopy. The measured current Iₜ is shifted in phase φ and has the amplitude of I₀, as seen in FIG. 6(a). Radial frequency

$$\\ ω ( \frac{radians}{seconds} )$$

is related to frequency f (Hertz) as follows:

ω=2πf

The impedance can be calculated by applying Ohm's law to the system:

$$\\ Z = \frac{{E}_{t}}{{I}_{t}} = \frac{{E}_{0} sin ( ω t )}{{I}_{0} sin ( ω t + φ )} = {Z}_{0} \frac{sin ( ω t )}{sin ( ω t + φ )}$$

If plotted the applied sinusoidal E(t) on the X-axis and response signal I(t) on the Y-axis result in an oval, as seen in FIG. 6(b). This is known as a “Lissajous Figure” and was the accepted method of impedance measurement before availability of modern EIS instrumentation.

The impedance can be represented as a complex number with the use of Euler's theorem:

$$\\ {e}^{( j φ )} = cos ( φ ) + j sin ( φ )$$

$$\\ {E}_{t} = {E}_{0} {e}^{( j ω t )}$$

$$\\ {I}_{t} = {I}_{0} {e}^{( j ω t - φ )}$$

$$\\ Z ( ω ) = \frac{E}{I} = {Z}_{0} {e}^{( j φ )} = {Z}_{0} ( cos φ + j sin φ )$$

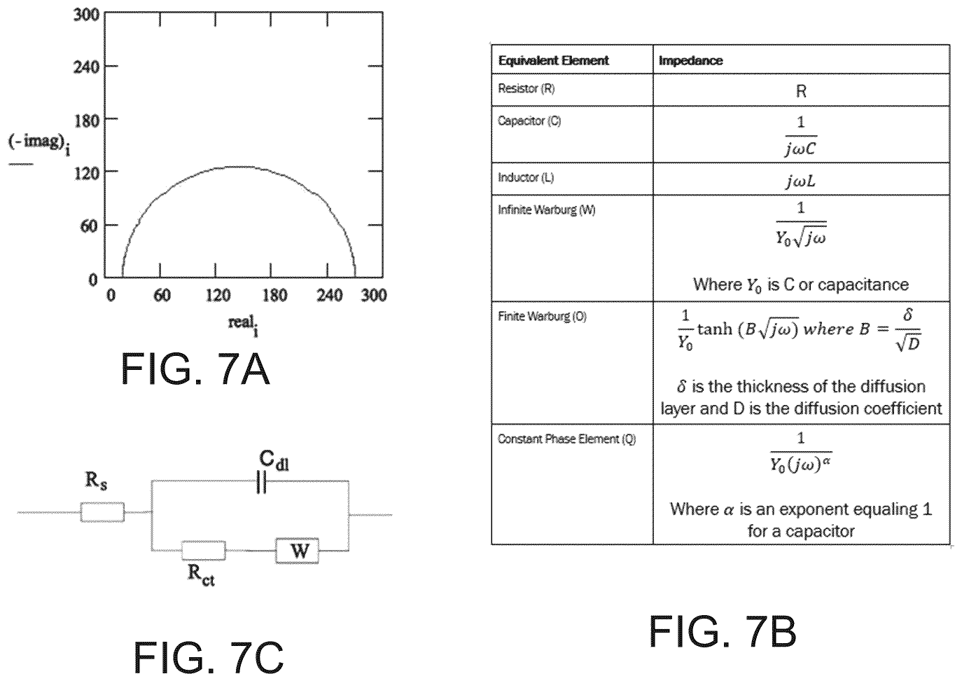

Resulting complex impedance (Z) data is visualized as Nyquist plot that shows the real impedance (Z′) vs. imaginary impedance (Z″), as seen in FIG. 7A, which is an example of a Nyquist plot of a simplified Randles Cell.

For measurement of a transducer with the use of EIS, it is important to understand equivalent circuit model that the transducer inherently possess. These circuit models will be made up entirely of the circuit elements of FIG. 7B, which shows a table of impedance formulas according to one embodiment.

In one example, the work is specifically concentrated on mixed kinetic and diffusion control systems. The measurement system will see an equivalent circuit of FIG. 7C, which shows an example of Randles Cell as an equivalent circuit with mixed kinetic and charge-transfer control, where Rₛ=solution resistance.

### Minimum Required Component PCB

This disclosure includes the hardware and software to perform electrochemical measurements in forward operating environments to monitor the area for chemical contaminates of interest (analytes), and the hardware and software to deploy, orientation correct, collect, identify, and transmit environment information. A key element of this endeavor is a custom PCB that is based around an integrated component (IC) made by Analog Devices, such as the ADuCM355. This IC is a microcontroller and potentiostat combination that allows for traditional electrochemical techniques to be performed in a low cost, low power, minimum component package or system on chip (SoC). The ADuCM355 IC is a voltammetry system controller and may be referred to as a custom potentiostat board. One example of the design is based on some recommended components and layout designs from Analog Devices while also incorporating custom components.

This potentiostat board may be used for performing electrochemical measurements based on known standards: cyclic voltammetry (CV), square wave voltammetry (SWV), and electrochemical impedance spectroscopy (EIS). The tests are methods for quantifying the presence of analytes by applying a known signal and measuring the response on a voltammetry sensor.

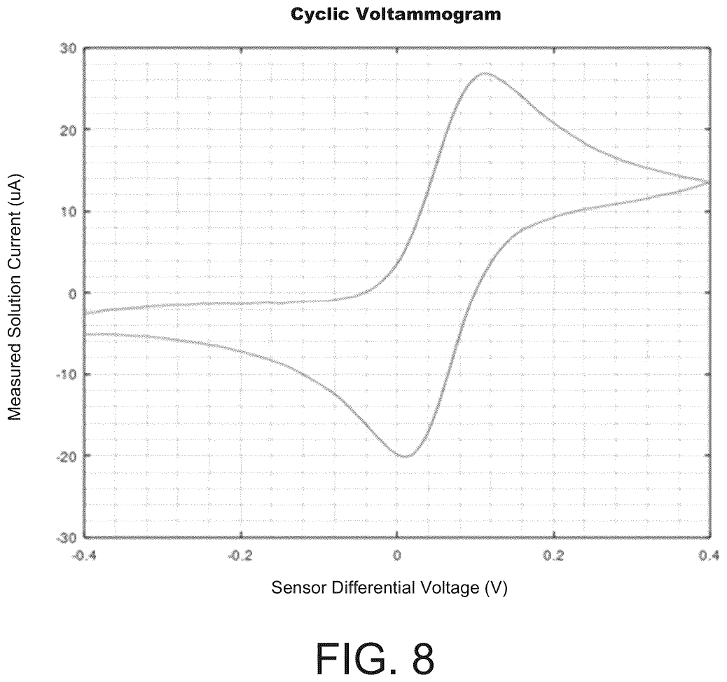

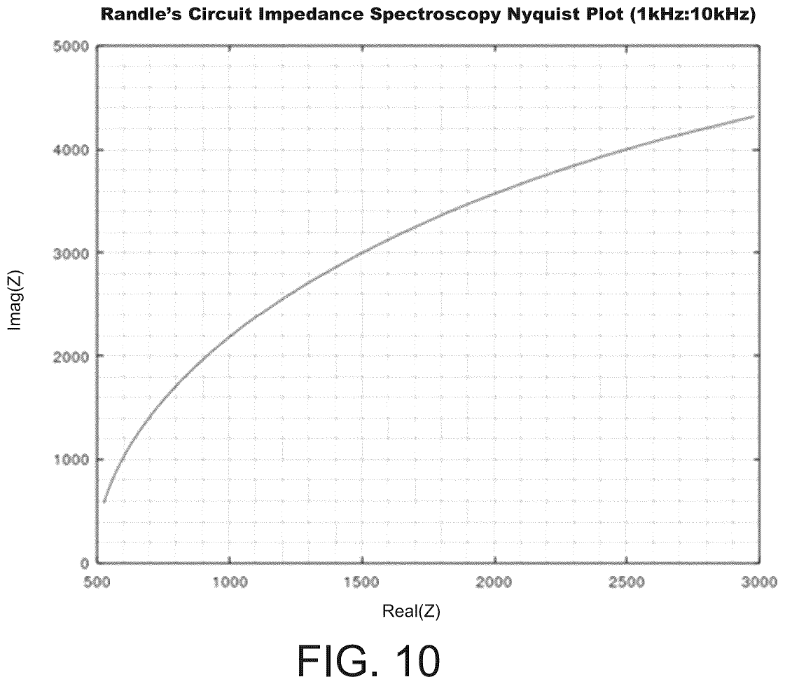

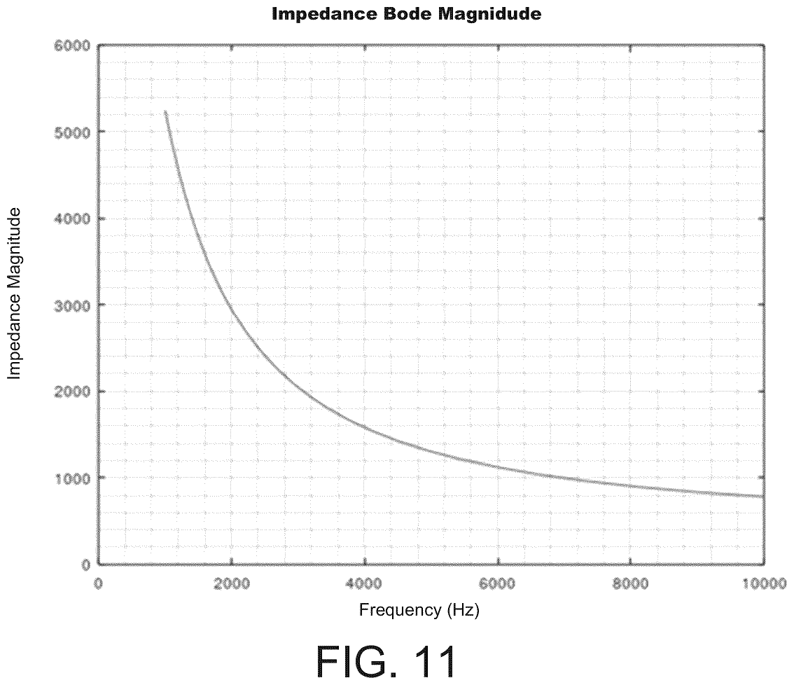

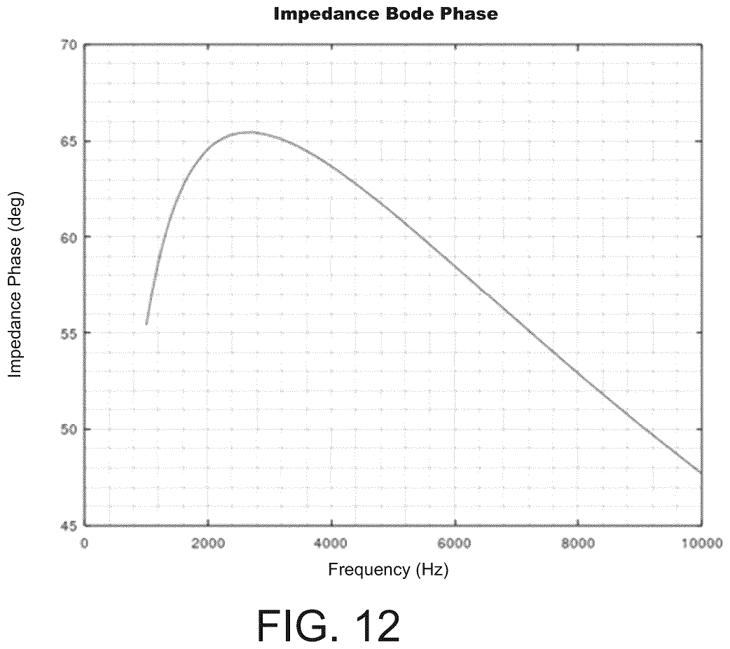

Visual examples of these types of measurement techniques using the ADuCM355 IC are shown in FIGS. 8-12. FIG. 8 shows an example of a cyclic voltammogram for CV. FIG. 9 shows an example of a square wave voltammogram for SWV. FIG. 10 shows an example of a Randles circuit impedance spectroscopy Nyquist plot for EIS. FIG. 11 shows an example of an impedance Bode magnitude plot for EIS. FIG. 12 shows an example of an impedance Bode phase plot for EIS. These measurements were performed using an electrode submerged in ferrocenemethanol. Firmware is developed and programmed onto the ADuCM355 to perform these measurements and print out the data.

A minimum schematic was created for the ADuCM355. The minimum required schematic started from the schematic of the development board, but everything was stripped down except for the required components in order to read sensors and program the board. The ADuCM355 itself is the main component and it is surrounded by supporting components such as a 32 MHz crystal and capacitors. There are two outputs for connecting to sensors, EC Sensor 1 and EC Sensor 2. In this example, the board has two potentiostats. In other examples, fewer or more potentiostats may be used. There is one input header for programming and powering the device.

### Differential Current Limiting

This disclosure presents a technique for substantially extending the lifespan of screen-printed electrochemical sensors by preventing differential currents from exceeding levels that damage the sensor. Application of high differential electrical currents for extended periods cause physical sensor damage by electrodeposition of metallic ions onto the sensor electrodes. This process changes the electrical conductivity of the sensor, and damaged sensors produce inconsistent and unreliable measurements. To limit or contain problems associated with sensor damage, the differential current through the working electrode of a screen-printed sensor is actively monitored in real time. The current is sampled at the top and at the bottom of a square wave voltammetry step as illustrated in FIG. 4 and FIG. 5A. A predictive algorithm is employed to determine if the differential current will exceed the differential current threshold of the sensor before it actually reaches the threshold. Thus, if the sensor is on a trajectory to exceed the set differential current limits, the voltammetry test can stop and/or an alert can be generated to preserve the sensor and/or retry the test.

To protect the electrodes from too high of a differential current, the firmware contains an algorithm for predicting what future values of the differential current response will be based upon previous trends. An excessive differential current can damage the sensor electrodes and deem it unusable which with deployable sensors is not an option. Two current measurements are made at each point in the SWV cycle as seen in FIG. 5A. In this figure, the points labeled “Sample Period (i_{f})” and “Sample Period (iᵣ)” are the two points where the current measurements are made for each cycle. The difference between these two values result in the plot seen in FIG. 9 when plotted against the applied potential. In specific embodiments, this difference in current is what is being tracked to predict whether a response that is too high will be seen.

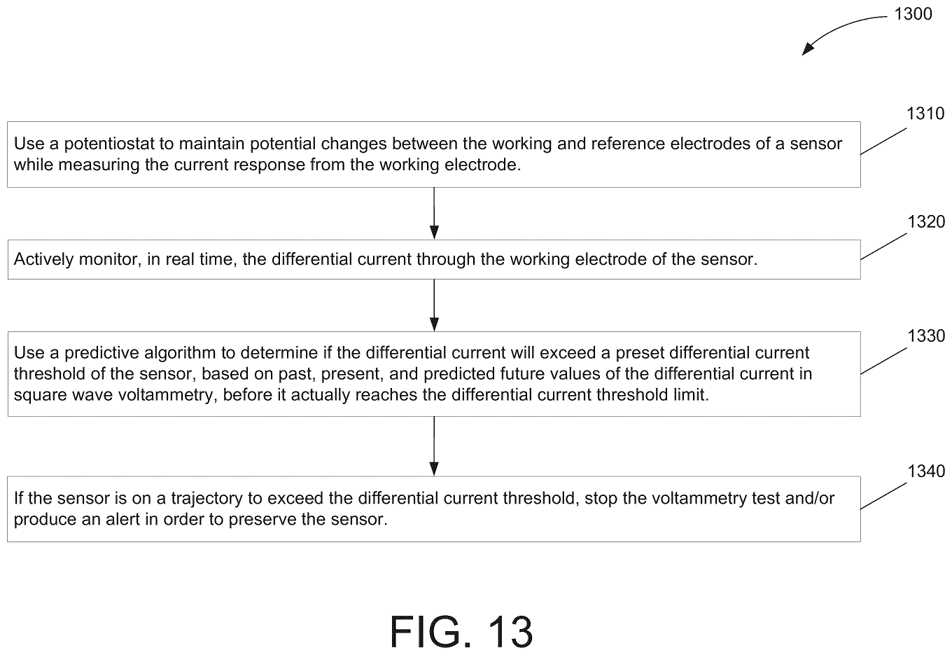

FIG. 13 is a flow diagram illustrating an example of a process 1300 of differential current limiting for voltammetry sensor lifetime extension. In step 1310, the process uses a potentiostat to maintain potential changes between the working and reference electrodes of a sensor such as a voltammetry sensor or a 3-electrode sensor. The current response is measured from the working electrode (e.g., between the working electrode and a counter electrode). In step 1320, the process actively monitors, in real time, the differential current through the working electrode of the sensor. An approach is described above in connection with FIG. 5A. In step 1330, the process uses a predictive algorithm to determine if the differential current will exceed a preset differential current threshold of the sensor. One predictive algorithm predicts future values of the differential current based on past and present values of the differential current in square wave voltammetry and compares the predicted future values with the preset differential current threshold, before it actually reaches the threshold limit. In step 1340, if the sensor is on a trajectory to exceed the differential current threshold, the process may stop the voltammetry and/or produce an alert to notify the operator who may take remedial action, in order to preserve the sensor from becoming damaged and unusable.

The differential current threshold may be preset by the operator. As more testing is done, a more accurate value may emerge which will be a more test proven value for a particular set of electrodes in the electrochemical sensor. The algorithm will work with different electrode sensors utilizing square wave voltammetry, but the thresholds may be different.

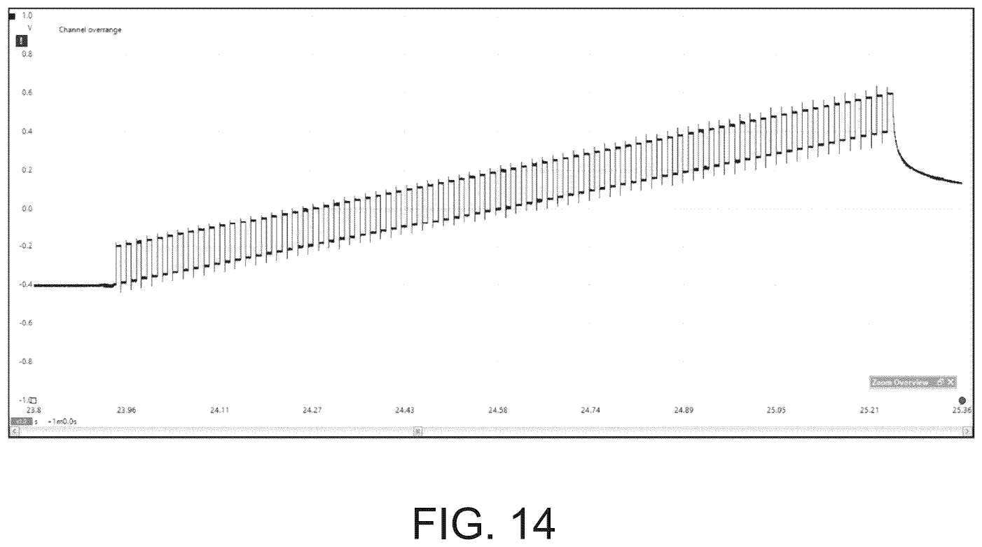

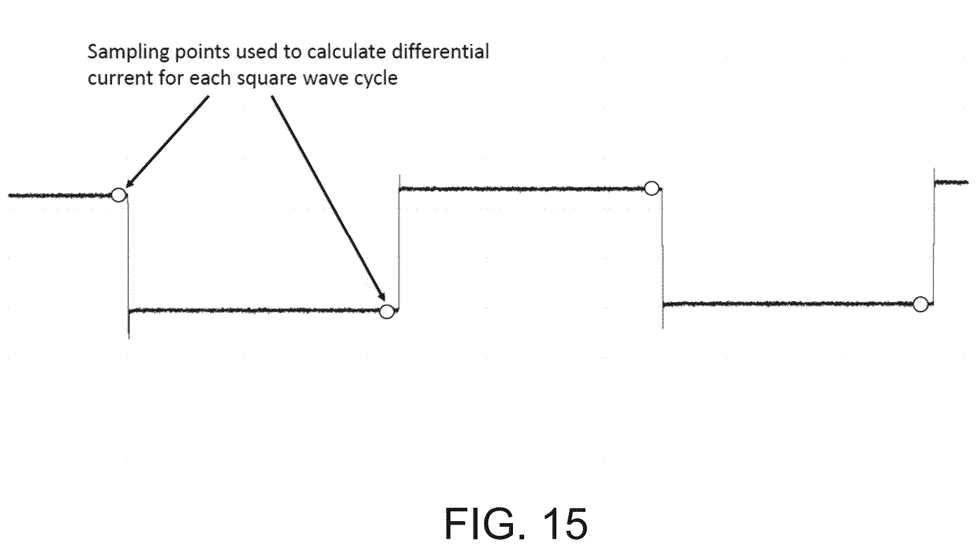

The following is an example of applying the differential current limiting process 1300. FIG. 14 shows an example of a simplified square wave voltammetry forcing function or excitation signal used in sensor test cases to illustrate the process of differential current limiting. FIG. 15 shows an example of sampling points which are used to calculate differential current for each square wave cycle in the example of FIG. 14.

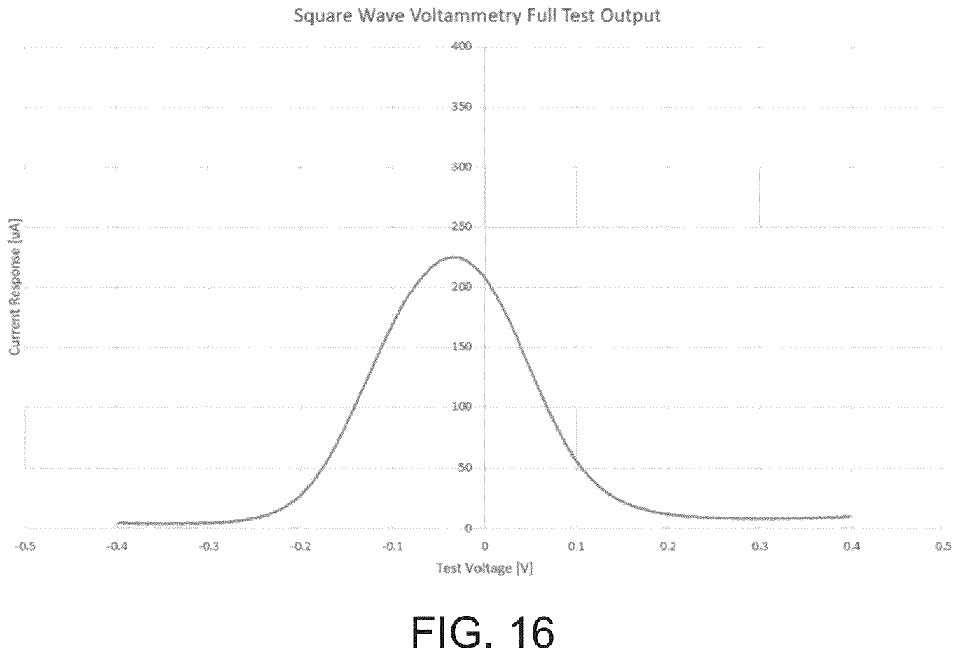

FIG. 16 shows an example of a full test output of a square wave voltammogram for a sensor test case of FIG. 14 in which the projected differential current does not exceed the differential current threshold. In this example, the differential current threshold/limit is set by the user to about 350 μA.

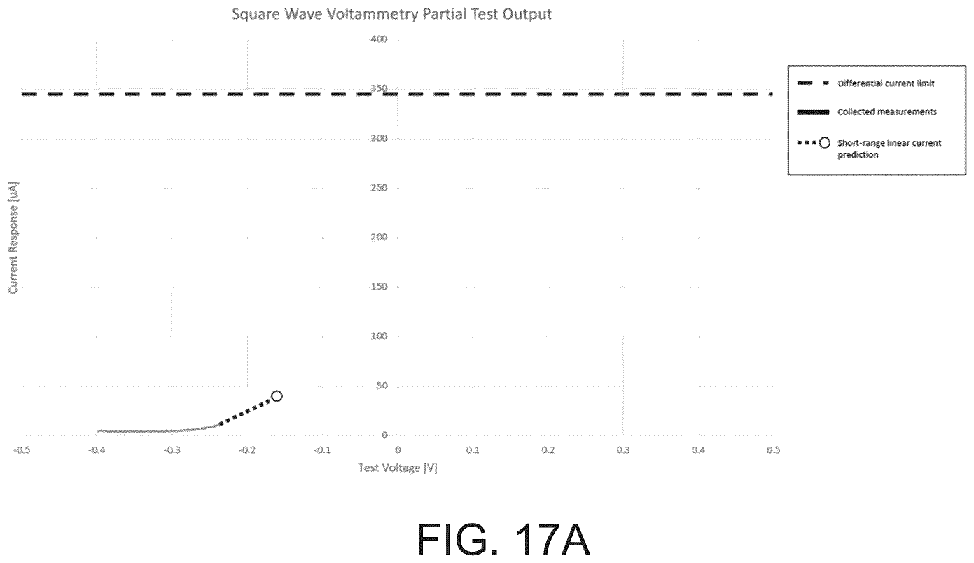

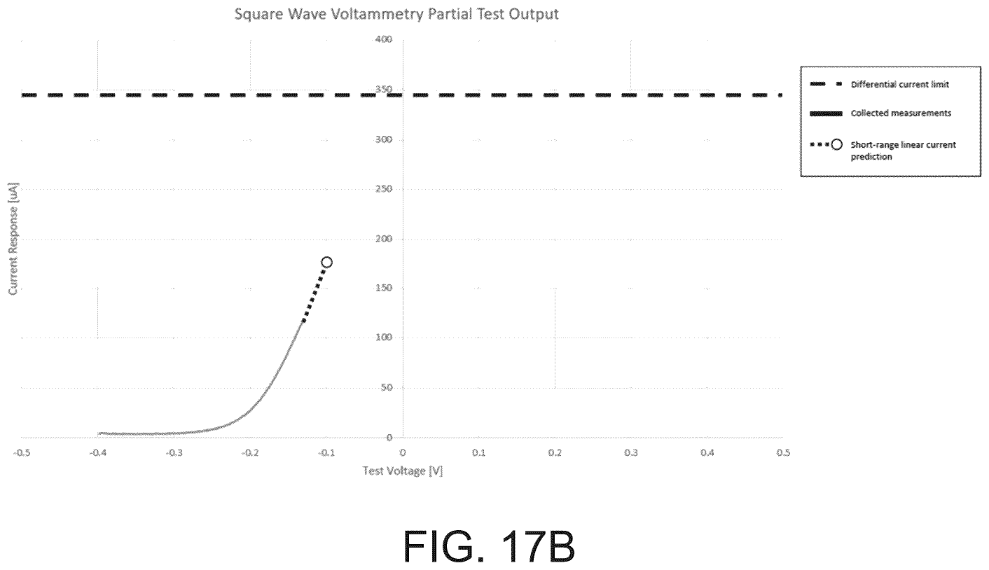

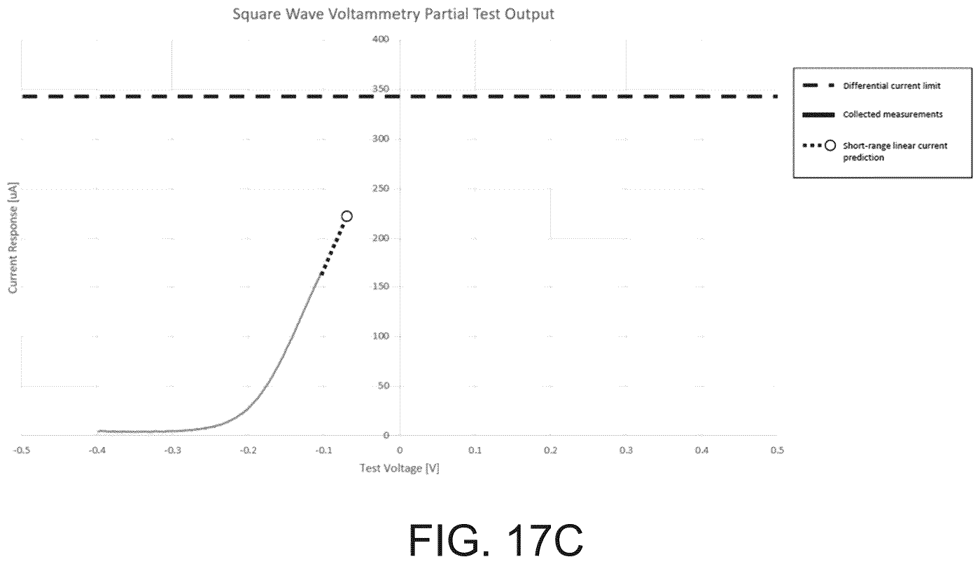

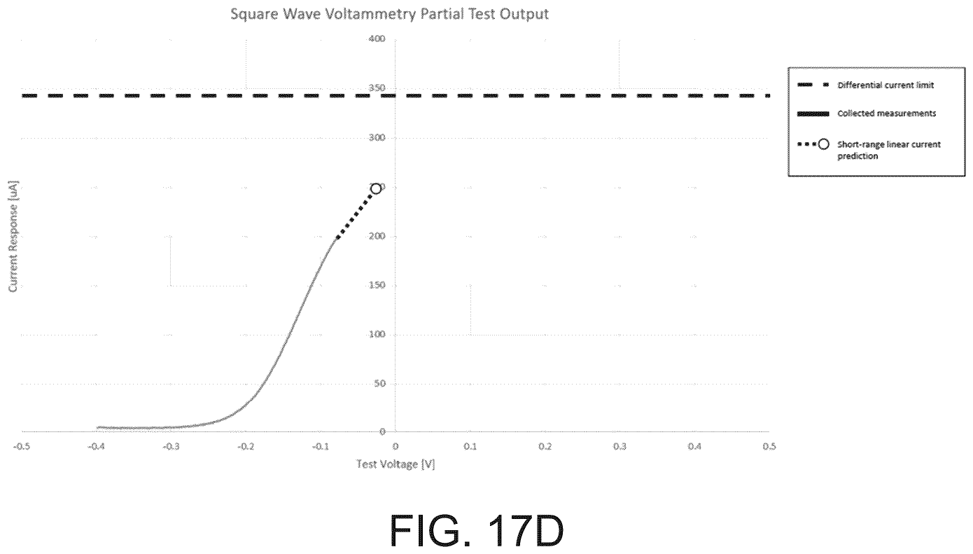

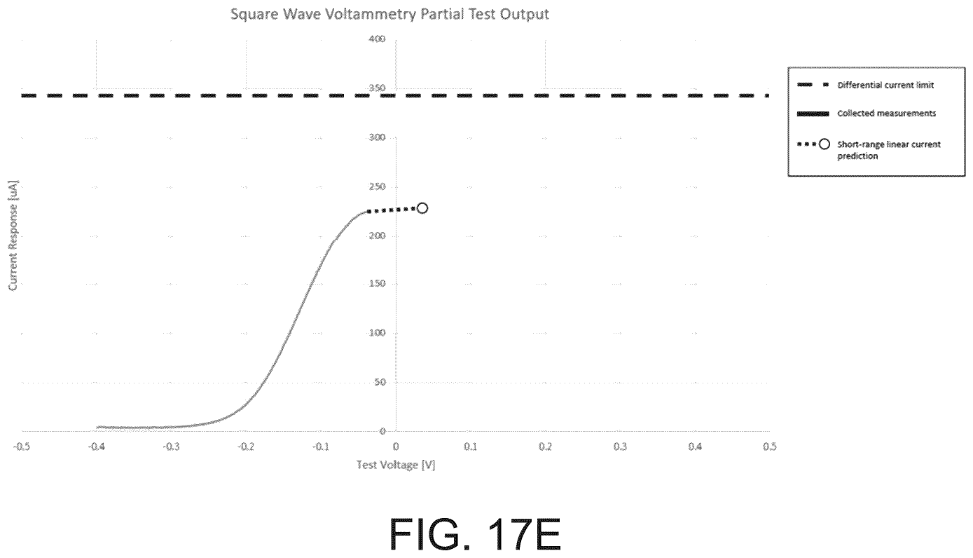

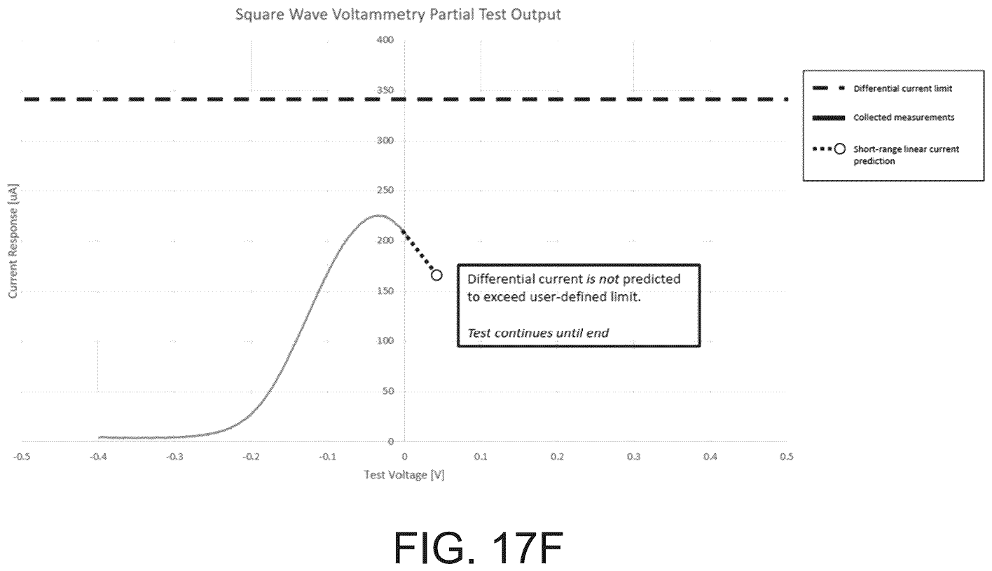

FIGS. 17A-17F show partial test outputs of the square wave voltammogram in the example of FIG. 16. The solid line of the plot represents collected measurements by actively monitoring, in real time, the differential current through the working electrode of the sensor. The broken line of the plot represents the projected differential current using short-range linear current prediction for which short-range future values of a discrete-time signal are estimated as a linear function of previous samples. Of course, in other embodiments, different prediction algorithms may be used.

In FIG. 17A, the projected differential current reaches about 45 μA. In FIG. 17B, the projected differential current reaches about 175 μA. In FIG. 17C, the projected differential current reaches about 225 μA. In FIG. 17D, the projected differential current reaches about 250 μA. In FIG. 17E, the projected differential current begins to flatten and reaches about 227 μA. In FIG. 17F, the projected differential current drops below about 170 μA. Because the projected differential current does not exceed the preset threshold of 350 μA, the test is allowed to continue until the full test output of the square wave voltammogram of FIG. 16 is generated.

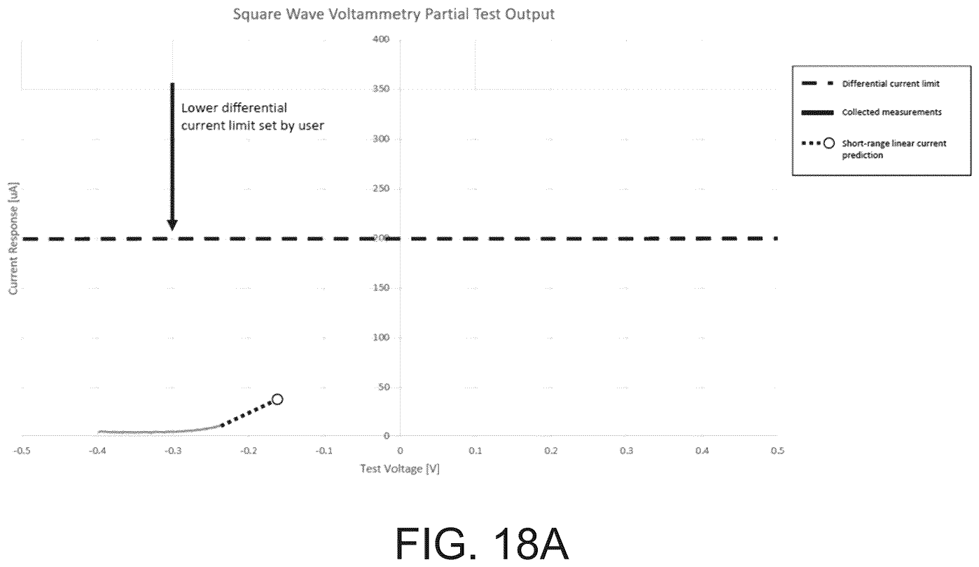

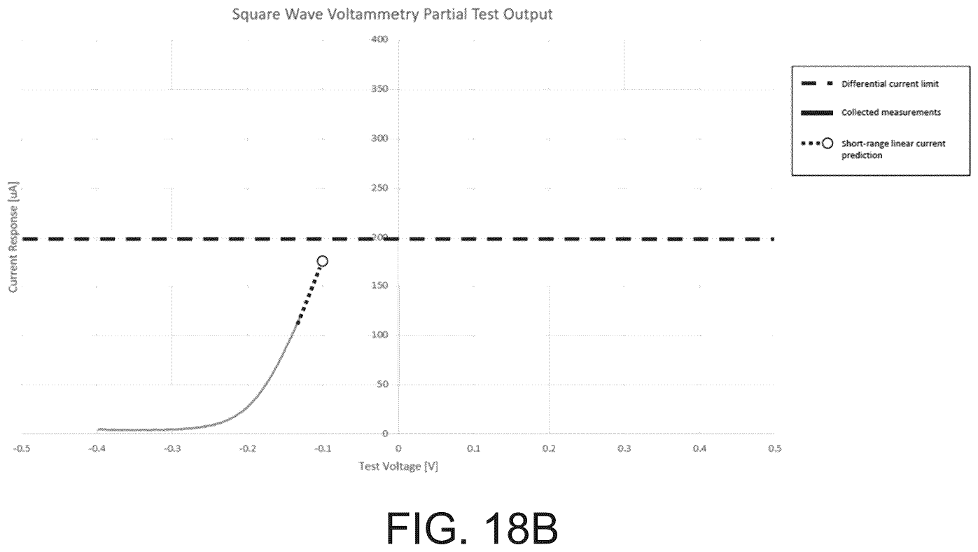

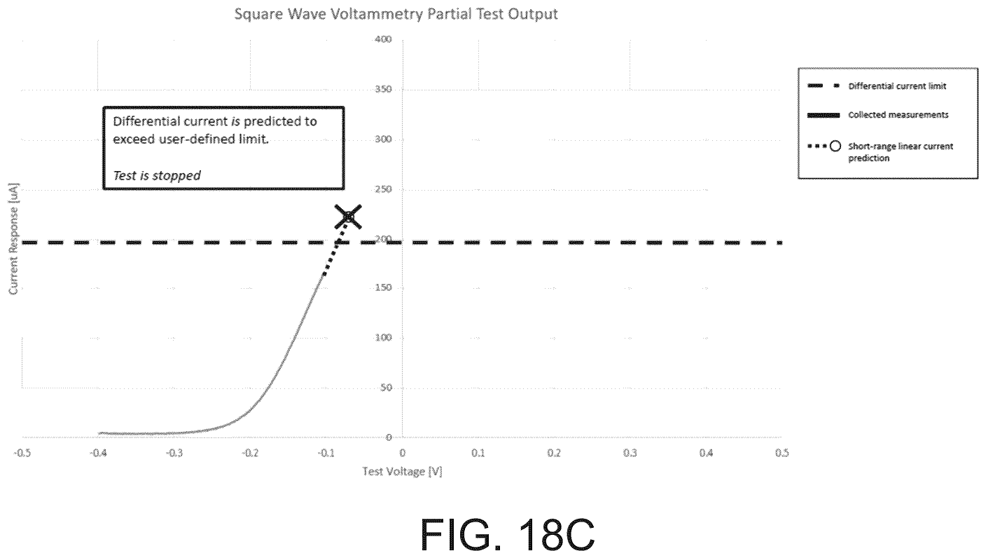

FIGS. 18A-18C show partial test outputs of another example of a square wave voltammogram for another sensor test case of FIG. 14 in which the projected differential current exceeds the differential current threshold. In this example, the differential current threshold/limit is set to about 200 μA. The solid line of the plot represents collected measurements and the broken line of the plot represents the projected differential current using short-range linear current prediction. In FIG. 18A, the projected differential reaches about 45 μA. In FIG. 18B, the projected differential current reaches about 175 μA. In FIG. 18C, the projected differential current reaches about 225 μA, exceeding the preset threshold of 200 μA. Because the differential current is predicted to exceed the preset threshold, the test is stopped.

### Wireless Data Transfer

Several wireless transmission protocols are available and investigated. Long Range (LoRa) may be chosen as the primary method for data transfer. LoRa boasts the ability to transmit data over an extremely long distance while maintaining a small package size and using little power for transmission. Two main development platforms for LoRa development are the LoPy4 by Pycom and the Arduino MKR WAN 1310.

The LoPy4 is a development board from Pycom with four different radio interfaces (WiFi, Bluetooth, LoRa, and Sigfox). The quadruple network capabilities allow LoPy4 to function as nodes and gateways. The nodes use LoRa radio as the long-range communication protocol, while the WiFi radio capabilities on the board allow it to act as the gateway to connect to the Internet. For complex integration of the LoPy4 board, the device is programmable in MicroPython. MicroPython is compatible with Python 3, written in C, with optimized modules to give programmers access to low-level hardware with ease.

The LoPy4 MicroPython and Pymakr plugins allow for fast Internet of Things (IoT) application development. Pymakr has the capability to be programmed in-field and resilient with network failure. LoPy4 board can transfer packages in raw LoRa mode to send packages directly between nodes. Data can transfer at a distance of up to 40 km. Pycom offers an expansion board called Pysense that offers several sensors at a quick start. While both boards offer low power modes, LoPy4 uses 15 mA in active mode and 1-uA in standby mode for the LoRa and the Pysense expansion board can go as low as ˜1 uA in a deep sleep.

The Arduino MKR WAN 1310 is a low-powered, open source board that can be used for receiving and transmitting data in LoRa networking applications. This board may be considered for this application primarily for its encryption capabilities, lower power consumption levels, and the availability of open source libraries to be used in conjunction with the board.

Security capabilities for this board may be defined by Microchip's ATECC508A chip, which provide network/IoT node protection, anti-counterfeiting, protecting firmware or media, storing secure data, and checking user passwords. The chip “implements a complete asymmetric (public/private) key cryptographic signature solution based on Elliptic Curve Cryptography and the ECDSA signature protocol” and utilizes a SHA-256 hash algorithm for these functionalities (Microchip Technology Inc. 2017).

The low power consumption ratings of the MKR WAN 1310 may offer a significant advantage over other similar boards such as the Lopy4 board. Power draw was measured in a lab setting when the board was in sleep mode, when the board was awake but not yet transmitting data (idle mode), as well as during data transmission (active mode). These findings are summarized in the following Table for MKR WAN 1310 power draw per run state.

| Mode | Current Draw (mA) |
|---|---|
| Sleep | 0.64 |
| Idle | 14 |
| Active | 18 |

It should be noted that for this documented test, the current draw for the board in sleep mode was only with the LoRa transceiver turned off and with other peripherals left on. Retesting of the power consumption of this board in full deep sleep mode may see power draw as low as 104 uA (Microchip Technology Inc. 2018). The open source nature of the MKR WAN 1310 allows for seamless integration into LoRaWAN networks.

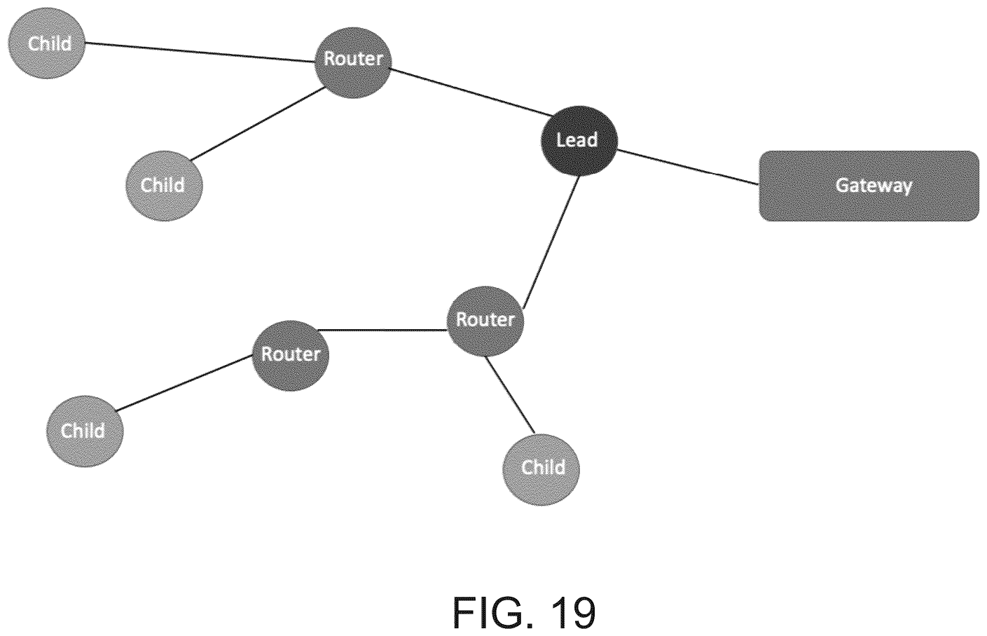

FIG. 19 shows an example of meshing routes. Utilizing a meshing network allows one to cover a broader area with a smaller ratio of gateways to nodes. The MKR WAN 1310 boards use the raw-LoRa radio to send packages from node to node. These nodes have node IDs to allow a comparison of other nodes to establish the best radio-link. Traditional meshing networks are static in nature, whereas the meshing network utilized in this work is dynamic and adaptable. The network has the ability to be flexible to reroute pathways, such as in cases where a node falls off the network or where a node is added to the network. The hierarchy of the meshing network is as listed: child, router, lead. The child nodes send their data to the most reliable network connection established. The routers handle sending and receiving packages to be routed to the lead node. The lead nodes receive data and send all node data to the gateway.

LoRaWAN: Long Range Wide Area Network is a Low Power, Wide Area (LPWA) network protocol used to manage battery-operated sensor devices to the Internet, specifically the Internet of Things (IoT) with uplink and downlink communication and security. The IoT are composed of devices, nodes that communicate wirelessly over long distances that are low-power, low-cost, and low-maintenance. Furthermore, LoRaWAN having these features offers a private network deployment that other LPWAN technologies cannot provide. Developed by LoRa Alliance, LoRaWAN is a network protocol that works efficiently through its minimal power consumption, secure data transmission, and long-range communication (15 km). With the low power consumption capability, LoRaWAN is designed to handle a vast network of nodes on a single gateway.

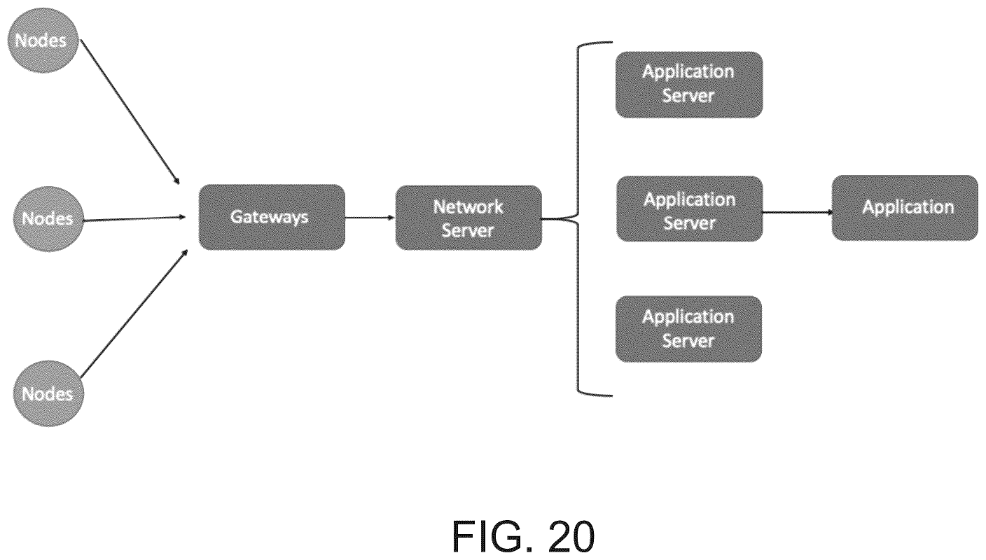

FIG. 20 shows an example the architecture of the LoRaWAN network. It is a star topology that only allows the end devices to communicate with the LoRaWAN gateways. The IP based server can be connected to multiple gateways where the gateways are only responsible for sending LoRa data packets from nodes to the network. A third-party application server is the final destination for the LoRa data packet that was sent from the end node; the network server can be connected to multiple application servers.

LoRaWAN supports three classes of end node devices, Classes A-C. Class A has a bidirectional communication enabled for uplink and a short downlink transmission. When the node transmits its package to the gateway, the device listens for a downlink. Class A node devices are asleep for the majority of their deployment, making them the least power consumption of the three classes. LoRaWAN has an Adaptive Data Rate (ADR) built in to manage an end node's link parameters (SF and transmit power) to increase the delivery ratio. However, it also allows the network server to manage the transmit parameters in the node uplink communication packet. They run asynchronously as the end node and network server.

End nodes can join the network through LoRaWAN's standards with personalization and activation. The devices used can be activated with over the air (OTAA) procedure. OTAA uses two symmetric session keys for secure communication: the AppSkey and NwkSkey. To generate these keys, the user will define the AppKey and NwkKey before activation. The AppSkey is encrypted with AES-128 to be used for end-to-end communication from a device to the application server. The NwkSkey handles the message security from a device to the LoRa Network Server. The end node sends a join request to the network server, and the server response with a join-accept message.

ChirpStack (Brocaar n.d.) LoRaWAN Network Server stack is open source with components to access networking protocol LoRaWAN with ease. The full stack provides user-friendly, ready to use web-interface to manage devices. The built-in components on ChirpStack that the projected uses are the gateway bridge, network server, and application server.

The LoRa gateway can simultaneously listen to 8 channels and receive the LoRa packages from the nodes to be sent to the ChirpStack Gateway Bridge by the Packet Forwarder. The multiple gateways used will connect to a single instance of the ChirpStack Gateway Bridge. The Gateway Bridge will convert the packet into a data format that will then be used by the ChirpStack components.

The state of the network is managed by the ChirpStack Network Server which is a LoRaWAN Network Server. This will handle the device activations on the network and the join-requests when the nodes are trying to join the network. Without user input, the Network Server can handle duplicate data sent and convert it into one payload. When the application needs to send a downlink message to the nodes, the ChirpStack Network Server will keep these items in a queue until the downlink message is sent to a gateway.

The final destination of the LoRa package that is sent from nodes goes to the ChirpStack Application Server. When the ChirpStack Application Server receives the data from the Network Server, the Application Server can send it to the many applications to which it can connect from ChirpStack. The data received is sent to InfluxDB in a time series. ChirpStack Application Server provides APIs and web-interface for gateways, devices, applications, users, and overall organization.

### Deployment

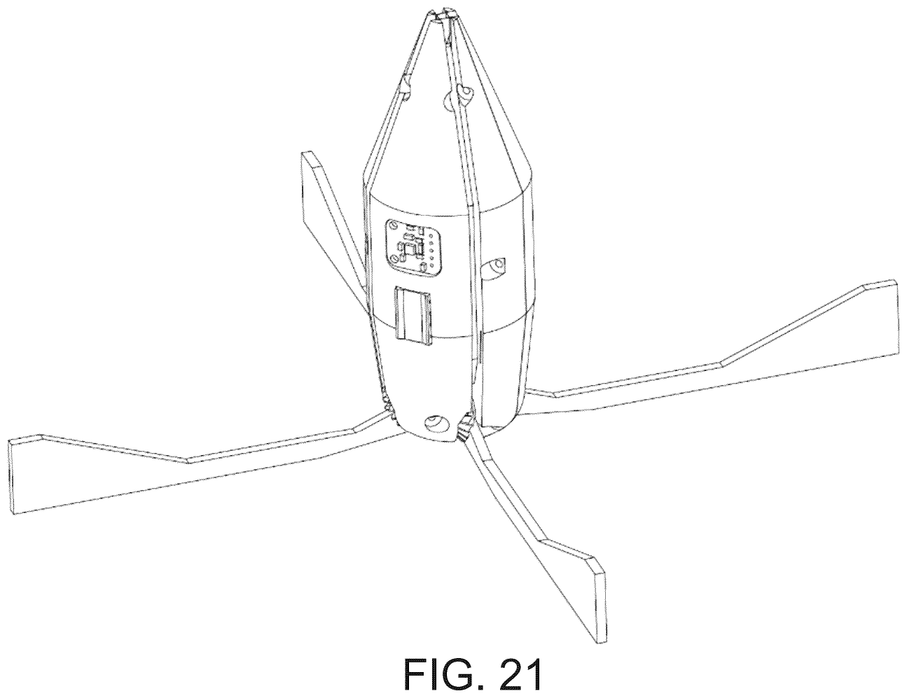

Another aspect of this disclosure is directed to a method of deploying these devices into remote regions or in areas inhospitable for people. At the time of deployment, the potentiostat board is programmed with GPS data to know where it is, a sensor capsule containing a sensor package and associated mechanism(s) is dropped, and then once on the ground the supporting legs may be extended using motors to correct the positioning. The capsule contains the electronics for the potentiostat measurements, the motor for self-righting, and the transceiver device for long-distance communication. FIG. 21 shows an example of a sensor capsule.

In an area of deployment, several of these capsules may be distributed to get a snapchat of the area and send data back to a main gateway that aggregates the results of all surrounding nodes. Long Range (LoRa) may be the RF protocol used to make these long-range transmissions. If the gateway itself is out of range from individual nodes, the nodes are able to communicate among themselves and relay the messages from the far nodes to the gateway.

The following discussion pertains to the design of the components designed for rapid deployment of a long-term sensor. The discussion will cover the three main design topics: (1) sensor package, (2) release mechanism, and (3) unmanned aerial vehicle (UAV). The design and configuration of these three main systems can determine the efficiency of sensors deployment.

Sensor Packaging

The design of the delivery system begins with the sensor package itself. The sensor package includes the sensor 110, voltammetry sensor measurement system or potentiostat board 120, and any other components to facilitate operation of the voltammetry system 100. The packaging may be designed to meet the following basic mission requirements. A drone can deliver multiple sensor packages in one flight. Sensors can have a wired connection to the drone's onboard computer. Lastly, the sensor package's antenna can be oriented in the upright position.

Design of the sensor begins with addressing the most difficult observed problem of orienting the antenna. This factor has the most significant impact on the design of the packaging; antenna alignment is the priority design challenge. Possible solutions to this design problem are a gravity teetering device, parachute capsule, or mechanical folding mechanism.

The shape of the capsule may be designed to force the sensor package to fall nose down, allowing shock absorbing measure to be limited to a single axis. At this point, internal volume requirements had not been determined; nor had an actuation mechanism been chosen.

The torque to open the folding arms of the sensor package may be estimated based on an estimated weight of the assembled sensor package and an estimated distance of the fin's hinge point to the center of mass of the capsule. In one example, the hypothetical torque to upright the capsule is greater than 0.92 in-lbs.

The stabilizing fins serve a second purpose of standing up the mechanism after reaching the ground. The mechanism may be designed to drive all the fins open simultaneously rather than individually. In one example, the individual fins contain a bevel gear built around their hinge point; these gears engage the adjacent fins' gears, forcing them to rotate in unison. Shape memory alloy (SMA) wire may be used to actuate the fins.

The sensor package may be compact, lightweight, and self-righting. Upon design finalization, 3D printed plastic components may be manufactured through injection molding. The packaging may include six 3D printed plastic pieces, four fins, and two shell halves.

Longer-term deployment of the sensor package may be achieved by implementing deep sleep on electrical devices and using two 3.5-volt lithium batteries with 2.2 amp hour capacity each. These batteries are designed specifically for their high-power density at low discharge rates. For even longer duration in the field, small solar cells may be used to offset the power consumption from the sensor package.

One way to achieve self-righting of the sensor package involves the use of SMA which, when under electrical current, contracts and acts as a small actuator. This contraction forces the fins of the sensor package to open, righting the assembly. Power to activate the SMA comes from either a small lithium battery or a super capacitor. With the actuation of the fins to self-right the sensor package, the sensor is then able to transmit data from its internal antenna.

SMA Wire Activation

To activate the SMA wire to upright the sensor capsule, a small charging circuit can be fashioned to deliver the required voltage and current to coil the wire. A laboratory experiment provided approximations of charging circuit requirements to deliver 6 Amps at 3.3 volts for a duration of 20 seconds.

An energy storage device, most likely a capacitor, may be charged either by the UAS delivery system or charged prior to loading onto the UAS. Upon landing, the on-board microcontroller may close a switch and discharge the stored energy into the SMA wire, causing the wire to coil and raise the capsule.

The energy storage device may be chosen with considerations to capacity and form factor. Capacity may be chosen to satisfy:

$$\\ {V}_{t = 20} = {V}_{t = 0} {e}^{- \frac{t}{RC}} = 3.3 V$$

$$\\ {I}_{t = 20} = \frac{{V}_{t = 0}}{R} {e}^{- \frac{t}{RC}} = 6 A$$

where:
t=Elapsed time in seconds
R=Resistance of the SMA wire
C=Capacitance.

A final state of 6 A at 3.3V may be achieved after 20 seconds to deliver the required energy to the SMA wire to raise the capsule. After the SMA wire is coiled and the capacitor discharged, this circuit will be obsolete and no further control of switches is required.

Form factor may be the limiting factor in this design. Given the small amount of space inside the capsule (12 cubic inches), the charging circuit size will need to be minimal. Using MOSFETS as switching devices, the printed circuit board itself will be extremely small; however, to deliver the power required for the SMA wire, the energy storage device will occupy most of the internal volume of the capsule.

Carriage

The release mechanism may be designed to hold a minimum of six sensor packages and make a communication connection from the sensor package to the onboard computer of the UAV. The evaluation criteria include size, weight, and amount of supporting electronics.

A higher importance may be given to the criterion of limiting the supporting electronics. As such, this becomes the basis of the release mechanisms design. Electronics targeted to be simplified by the mechanical design are the electronics to control the release mechanism and electronics used in communication to the sensor packages. One simple design employs a single motor for the release mechanism and a single USB connection for communication without use of any IO pins of the on-board computer.

The importance of simplified electronics discards the use of multiplexing for communication to the sensor packages. As such, a mechanical connection to each sensor package may be implemented. This can be accomplished by using a single motor that releases all the sensor packages and creates a connection to them all as well.

The release mechanism takes the form of a revolving cylinder with multiple (e.g., six) sensor packages placed around its circumference and pieces of polycarbonate on each of the ends. The revolving cylinder may be a single piece of 3D printed plastic that holds the sensor packages in an upright orientation. The mechanism also contains a secondary 3D printed support structure, which houses the motor-mechanism and provides a mechanism for USB connection to the sensor packages. Other components of the mechanism include aluminum stand offs connecting the two end pieces of polycarbonate.

The secondary 3D printed structure provides a mechanism of USB connection to the sensor packages by a contact USB connection. The rotating cylinder moves each sensor package into position where the contact USB makes a connection. This mechanism allows each of the sensor packages to connect to the onboard companion computer before being released.

The release of the sensor packages occurs when the cylinder rotates to a portion of the polycarbonate sheet with a section removed from it. This allows the sensor package to drop through the cut-out section of the sheet and free fall to its deployment location. This mechanical design requires neither supporting electronics such as a multiplexing circuitry to connect to each sensor package nor servos to release sensor packages.

UAV

Selection of a drone to deliver the sensor packages may have some basic screening requirements. The first requirement is having an open source flight controller, because the use of a proprietary system blocks integration of custom hardware and software to interconnect. The second requirement may be that the lift capacity is 10 pounds or greater. This provides a cushion room as a final release mechanism and sensor package has yet been established.

The use of a drone may be the ideal method of sensor delivery. The requirements of such a platform are kept to a minimum by the small size of the sensor package. As a test platform, the UAV requirements are skewed towards over-compensation. An example of the drone is an eight-rotor, small, unmanned aircraft system (sUAS) with a payload capacity of 28 pounds.

The relatively large size of this flying platform allows for a broad selection of companion computers to be mounted. One example of a selected companion computer is a Raspberry Pi. Computers that are more powerful may be added in the future if increased processing power is required.

The companion computer is to provide three main functions: program sensor package before release, operate motorized release mechanism, and provide navigation to the sUAS through the Robot Operating System (ROS).

Computer Control

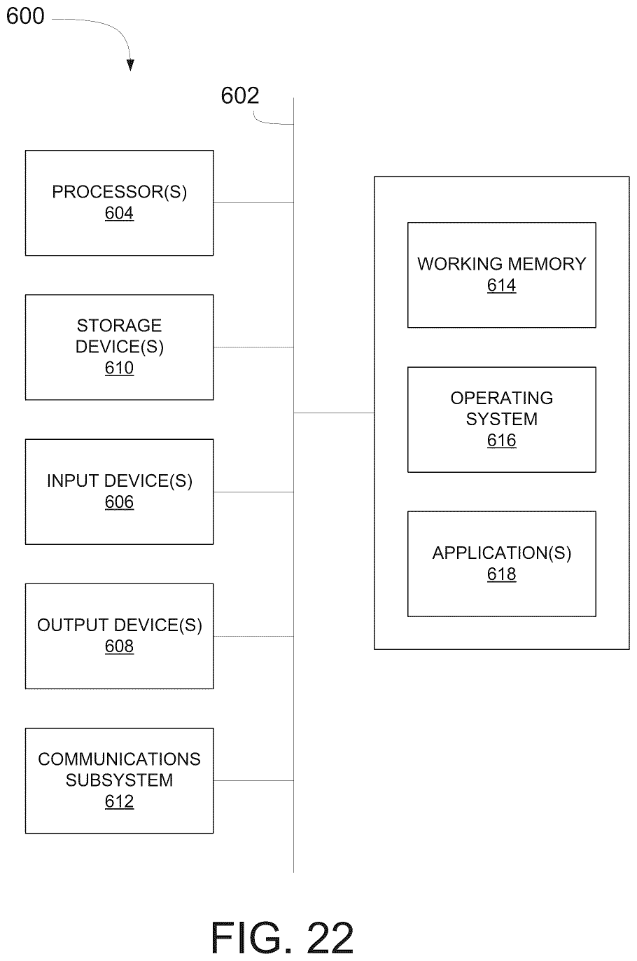

As a possible embodiment of the voltammetry system controller 120, the computer device 600 of FIG. 22 is shown comprising hardware elements that may be electrically coupled via a bus 602 (or may otherwise be in communication, as appropriate). The hardware elements may include a processing unit with one or more processors 604, including without limitation one or more general-purpose processors and/or one or more special-purpose processors (such as digital signal processing chips, graphics acceleration processors, and/or the like); one or more input devices 606, which may include without limitation a remote control, a mouse, a keyboard, and/or the like; and one or more output devices 608, which may include without limitation a presentation device (e.g., controller screen), a printer, and/or the like. Input to the computer system 600 may be provided by analog-to-digital converters to convert the measurement signals from the potentiostat 124, and any other measurement devices into digital form for storage and/or processing. Separate external analog-to-digital devices can be attached to the bus 602 or communication subsystem 612 to provide measurements in digital form to the computer system 600. In some cases, an output device 608 may include, for example, a display subsystem, a printer, a fax machine, or non-visual displays such as audio output devices. The display subsystem may be a cathode ray tube (CRT), a flat-panel device such as a liquid crystal display (LCD), a projection device, or the like. The display subsystem may also provide a non-visual display such as via audio output devices. In general, use of the term “output device” is intended to include a variety of conventional and proprietary devices and ways to output information from computer system 600 to a user. Output from the computer system 600 may be provided to digital-to-analog converters to send control signals from the computer to the electrochemical sensor 110 and any other controlled components used in other embodiments. Digitally controlled motors or actuators may be attached to the bus 602 or communication subsystem 612 for digital control by the computer.

The computer system 600 may further include (and/or be in communication with) one or more non-transitory storage devices 610, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 600 can also include a communications subsystem 612, which may include without limitation a modem, a network card (wireless and/or wired), an infrared communication device, a wireless communication device and/or a chipset such as a Bluetooth device, 802.11 device, Wi-Fi device, WiMAX device, cellular communication facilities such as GSM (Global System for Mobile Communications), W-CDMA (Wideband Code Division Multiple Access), LTE (Long Term Evolution), and the like. The communications subsystem 612 may permit data to be exchanged with a network (such as the network described below, to name one example), other computer systems, controllers, and/or any other devices described herein. In many embodiments, the computer system 600 can further comprise a working memory 614, which may include a random access memory and/or a read-only memory device, as described above.

The computer device 600 also can comprise software elements, shown as being currently located within the working memory 614, including an operating system 616, device drivers, executable libraries, and/or other code, such as one or more application programs 618, which may comprise computer programs provided by various embodiments, and/or may be designed to implement methods, and/or configure systems, provided by other embodiments, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code can be stored on a non-transitory computer-readable storage medium, such as the storage device(s) 610 described above. In some cases, the storage medium might be incorporated within a computer system, such as computer system 600. In other embodiments, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 600 and/or might take the form of source and/or installable code, which, upon compilation and/or installation on the computer system 600 (e.g., using any of a variety of generally available compilers, installation programs, compression/decompression utilities, and the like), then takes the form of executable code.

It is apparent that substantial variations may be made in accordance with specific requirements. For example, customized hardware might also be used, and/or particular elements might be implemented in hardware, software (including portable software, such as applets, and the like), or both. Further, connection to other computing devices such as network input/output devices may be employed.

As mentioned above, in one aspect, some embodiments may employ a computer system (such as the computer device 600) to perform methods in accordance with various embodiments of the disclosure. According to a set of embodiments, some or all of the procedures of such methods are performed by the computer system 600 in response to processor 604 executing one or more sequences of one or more instructions (which might be incorporated into the operating system 616 and/or other code, such as an application program 618) contained in the working memory 614. Such instructions may be read into the working memory 614 from another computer-readable medium, such as one or more of the storage device(s) 610. Merely by way of example, execution of the sequences of instructions contained in the working memory 614 may cause the processor(s) 604 to perform one or more procedures of the methods described herein.

The terms “machine-readable medium” and “computer-readable medium,” as used herein, can refer to any non-transitory medium that participates in providing data that causes a machine to operate in a specific fashion. In an embodiment implemented using the computer device 600, various computer-readable media might be involved in providing instructions/code to processor(s) 604 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 610. Volatile media may include, without limitation, dynamic memory, such as the working memory 614.

Exemplary forms of physical and/or tangible computer-readable media may include a floppy disk, a flexible disk, hard disk, magnetic tape, or any other magnetic medium, a compact disc, any other optical medium, ROM, RAM, and the like, any other memory chip or cartridge, or any other medium from which a computer may read instructions and/or code. Various forms of computer-readable media may be involved in carrying one or more sequences of one or more instructions to the processor(s) 604 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 612 (and/or components thereof) generally can receive signals, and the bus 602 then can carry the signals (and/or the data, instructions, and the like, carried by the signals) to the working memory 614, from which the processor(s) 604 retrieves and executes the instructions. The instructions received by the working memory 614 may optionally be stored on a non-transitory storage device 610 either before or after execution by the processor(s) 604.

It should further be understood that the components of computer device 600 can be distributed across a network. For example, some processing may be performed in one location using a first processor while other processing may be performed by another processor remote from the first processor. Other components of computer system 600 may be similarly distributed. As such, computer device 600 may be interpreted as a distributed computing system that performs processing in multiple locations. In some instances, computer system 600 may be interpreted as a single computing device, such as a distinct laptop, desktop computer, or the like, depending on the context.

A processor may be a hardware processor such as a central processing unit (CPU), a graphic processing unit (GPU), or a general-purpose processing unit. A processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512-bit, 256-bit, 128-bit, 64-bit, 32-bit, or 16-bit data operations.

Each of the calculations or operations discussed herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described herein. All features of the described systems are applicable to the described methods mutatis mutandis, and vice versa. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like. While the exemplary embodiments have been described in some detail, by way of example and for clarity of understanding, those of skill in the art will recognize that a variety of modification, adaptations, and changes may be employed.

As will be appreciated by one of ordinary skill in the art, the present invention may be embodied as an apparatus (including, for example, a system, a machine, a device, and/or the like), as a method (including, for example, a business process, and/or the like), as a computer-readable storage medium, or as any combination of the foregoing.

Embodiments of the invention can be manifest in the form of methods and apparatuses for practicing those methods.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A voltammetry sensor measurement system comprising:
one or more potentiostats configured to transmit an electrical input to a working electrode of a voltammetry sensor and to measure an electrical output from the voltammetry sensor in response to the transmitted electrical input, the electrical input including a square wave electrical input, the measured electrical output including a differential current through the working electrode of the voltammetry sensor; and
a controller coupled with the one or more potentiostats to monitor, in real time, the differential current through the working electrode of the voltammetry sensor;
the controller being configured to determine if the monitored differential current will exceed a preset differential current threshold of the voltammetry sensor, using a predictive algorithm based on the monitored differential current, before the differential current reaches the preset differential current threshold; and
the controller being configured to generate a signal when the monitored differential current is determined to exceed the preset differential current threshold, to preserve the voltammetry sensor before the differential current reaches the preset differential current threshold.

2. The voltammetry sensor measurement system of claim 1,
wherein the predictive algorithm makes use of past, present, and predicted future values of the differential current to anticipate whether or not the differential current will reach the preset differential current threshold before the differential current reaches the preset differential current threshold.

3. The voltammetry sensor measurement system of claim 1,
wherein the controller is configured, when the monitored differential current is determined to exceed the preset differential current threshold, to perform at least one of generating an alert or stopping the square wave electrical input from the one or more potentiostats to the voltammetry sensor, before the differential current reaches the preset differential current threshold.

4. The voltammetry sensor measurement system of claim 1, further comprising:
a user interface coupled with the controller to send information to and receive information from the controller;
wherein the controller is configured, when the monitored differential current is determined to exceed the preset differential current threshold, to perform at least one of sending an alert to the user interface or stopping the square wave electrical input from the one or more potentiostats to the voltammetry sensor, before the differential current reaches the preset differential current threshold.

5. The voltammetry sensor measurement system of claim 4,
wherein the user interface is coupled with the controller via a wireless connection.

6. The voltammetry sensor measurement system of claim 1,
wherein the square wave electrical input comprises a square wave voltage applied between the working electrode and a reference electrode of the voltammetry sensor, and
wherein the differential current is obtained based on a current measured between the working electrode and a counter electrode of the voltammetry sensor.

7. The voltammetry sensor measurement system of claim 1,
wherein the potentiostats are configured to measure the electrical output from the voltammetry sensor using cyclic voltammetry (CV), square wave voltammetry (SWV), and electrochemical impedance spectroscopy (EIS).

8. A sensor capsule including a plurality of sensor packages, each sensor package comprising a voltammetry sensor measurement system of claim 1 and a voltammetry sensor connected with the voltammetry sensor measurement system,
wherein each sensor package includes a communications subsystem having wireless communication capability to transmit and receive data wirelessly.

9. The sensor capsule of claim 8,
wherein the sensor capsule is configured to be deployable to a remote location and release and distribute the plurality of sensor packages at the remote location, and
wherein the plurality of sensor packages include communications subsystems having wireless communication capability to communicate via a wide area network (WAN).

10. A differential current limiting method for a voltammetry system, the method comprising:
configuring one or more potentiostats to transmit an electrical input to a working electrode of a voltammetry sensor and to measure an electrical output from the voltammetry sensor in response to the transmitted electrical input, the electrical input including a square wave electrical input, the measured electrical output including a differential current through the working electrode of the voltammetry sensor;
monitoring, in real time, the differential current through the working electrode of the voltammetry sensor;
determining if the monitored differential current will exceed a preset differential current threshold of the voltammetry sensor, using a predictive algorithm based on the monitored differential current, before the differential current reaches the preset differential current threshold; and
generating a signal when the monitored differential current is determined to exceed the preset differential current threshold, to preserve the voltammetry sensor before the differential current reaches the preset differential current threshold.

11. The differential current limiting method of claim 10,
wherein the predictive algorithm makes use of past, present, and predicted future values of the differential current to anticipate whether or not the differential current will reach the preset differential current threshold before the differential current reaches the preset differential current threshold.

12. The differential current limiting method of claim 10, further comprising, when the monitored differential current is determined to exceed the preset differential current threshold:
performing at least one of generating an alert or stopping the square wave electrical input from the one or more potentiostats to the voltammetry sensor, before the differential current reaches the preset differential current threshold.

13. The differential current limiting method of claim 12, further comprising, when the monitored differential current is determined to exceed the preset differential current threshold:
sending the alert to a user interface before the differential current reaches the preset differential current threshold.

14. The differential current limiting method of claim 10, further comprising:
deploying, to a remote location, a sensor capsule including a plurality of sensor packages, each sensor package comprising one voltammetry sensor measurement system connected with one voltammetry sensor; and
distributing the plurality of sensor packages at the remote location.

15. The differential current limiting method of claim 10, further comprising:
configuring the plurality of sensor packages with wireless communication capability to transmit and receive data wirelessly and to communicate via a wide area network (WAN).

16. An electrochemical sensor measurement system comprising:
one or more potentiostats configured to transmit an electrical input to a working electrode of an electrochemical sensor and to measure an electrical output from the electrochemical sensor in response to the transmitted electrical input, the electrical input including a square wave electrical input, the measured electrical output including a differential current through the working electrode of the electrochemical sensor; and
a controller coupled with the one or more potentiostats to monitor, in real time, the differential current through the working electrode of the electrochemical sensor;
the controller being configured to determine if the monitored differential current will exceed a preset differential current threshold of the electrochemical sensor, using a predictive algorithm based on the monitored differential current, before the differential current reaches the preset differential current threshold; and
the controller being configured to generate a signal when the monitored differential current is determined to exceed the preset differential current threshold, to preserve the electrochemical sensor before the differential current reaches the preset differential current threshold.

17. The electrochemical sensor measurement system of claim 16,
wherein the predictive algorithm makes use of past, present, and predicted future values of the differential current to anticipate whether or not the differential current will reach the preset differential current threshold before the differential current reaches the preset differential current threshold.

18. The electrochemical sensor measurement system of claim 16,
wherein the controller is configured, when the monitored differential current is determined to exceed the preset differential current threshold, to perform at least one of generating an alert or stopping the square wave electrical input from the one or more potentiostats to the electrochemical sensor, before the differential current reaches the preset differential current threshold.

19. The electrochemical sensor measurement system of claim 16, further comprising:
a user interface coupled with the controller to send information to and receive information from the controller;
wherein the controller is configured, when the monitored differential current is determined to exceed the preset differential current threshold, to perform at least one of sending an alert to the user interface or stopping the square wave electrical input from the one or more potentiostats to the electrochemical sensor, before the differential current reaches the preset differential current threshold, and
wherein the user interface is coupled with the controller via a wireless connection.

20. A sensor capsule including a plurality of sensor packages, each sensor package comprising an electrochemical sensor measurement system of claim 16 and an electrochemical sensor connected with the electrochemical sensor measurement system,
wherein the sensor capsule is configured to be deployable to a remote location and release and distribute the plurality of sensor packages at the remote location, and
wherein the plurality of sensor packages include communications subsystems having wireless communication capability to transmit and receive data wirelessly.
